(19) United States
(12) Patent Application Publication
(10) Pub. No.: US 2026/0163959 A1
(43) Pub. Date: Jun. 11, 2026

(54) DATA CACHING TECHNIQUES FOR DATA STREAMS

(71) Applicant: Oracle International Corporation, Redwood Shores, CA (US)

(72) Inventor: Hariprasad Mankude, Bellevue, WA (US)

(73) Assignee: Oracle International Corporation, Redwood Shores, CA (US)

(21) Appl. No.: 18/970,546

(22) Filed: Dec. 5, 2024

(51) Int. Cl. H04L 67/55; H04L 5/00; H04L 67/561

(52) U.S. Cl. CPC H04L 67/55; H04L 5/0044; H04L 67/561

(57) ABSTRACT

The disclosed systems, methods, and computer readable media relate to utilizing cluster of demultiplexer computing nodes to distribute control plane (CP) data events to data plane (DP) clients. In some embodiments, the nodes may be configured to obtain CP data events from a distributed streaming platform (e.g., Kafka). These CP data events may be associated with a stream ID and/or a combination of stream ID/sub-stream ID. The nodes may each be configured as a virtual instance implementing a smartNIC with persistent storage that is accessed via an NVMe protocol. The nodes may store CP data events within containers that are specific to the stream ID. This enables the order of events to be maintained across both stream ID and sub-stream ID. Any suitable number of DP clients may subscribe to a stream or stream/sub-stream associated with a respective node to obtain payloads corresponding to the subscribed stream or stream/sub-stream combination.

### BACKGROUND

In some cloud computing systems, control plane data is consumed by data plane clients. These data plane clients may include smart network interface cards that are configured with persistent memory. In conventional systems, control plane data is stored in a centralized data store. However, the centralized data store does not provide read scalability to serve a large number of data plane clients. Data plane clients often number anywhere between hundreds to hundreds of thousands data plane clients. Due to this deficiency, cloud service teams have previously developed customized distribution services to offload control plane data into a middle tier distribution service and use this middle tier distribution service as an end point for data plane clients. This included hard coding topics, keys, etc. with which data was published to the appropriate data clients. These customized distribution services are difficult to develop, difficult to maintain and/or update, and duplicate functionality unnecessarily. Improvements are desired.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

At least one embodiment includes a method. The method may comprise managing, by a cached log service of a cloud-computing service, a computing cluster comprising a plurality of demultiplexer computing nodes. In some embodiments, a demultiplexer computing node of the plurality of demultiplexer computing nodes may be configured to store control plane data within one or more containers. The method may comprise obtaining, by the cached log service from a distributed streaming platform, a control plane data event that is associated with a data stream provided by the distributed streaming platform. In some embodiments, the data stream may be associated with a stream identifier. The method may comprise storing, by the cached log service, the control plane data event within a container that is associated with the stream identifier and stored at a demultiplexer computing node of the plurality of demultiplexer computing nodes. The method may comprise updating, by the cached log service, container metadata corresponding to the container with metadata corresponding to the control plane data event. The method may comprise providing, by the cached log service, a payload corresponding to the control plane data event to one or more data clients that are subscribed to the data stream.

In some embodiments, the method may comprise adding a new demultiplexer computing node to the plurality of demultiplexer computing nodes based at least in part on identifying that the one or more data clients has increased in quantity.

In some embodiments, control plane data events are distributed to the distributed streaming platform according to a first distribution scheme, and the distributed streaming platform distributes the control plane data events to the plurality of demultiplexer computing nodes according to a second distribution scheme that differs from the first distribution scheme.

In some embodiments, the plurality demultiplexer computing nodes may be scaled to service 100,000 to 1,000,000 data clients within the cloud-computing environment.

In some embodiments, the cached log service is configured to allow data clients to subscribe to a data channel corresponding to a respective stream or a combination of the respective stream and a sub-stream that is associated with respective steam.

The method may further comprise receiving, from a data client, a bootstrap request corresponding to the data stream, and providing, to the data client, a snapshot that was previously generated to include a sequential list of control plane data events corresponding to the data stream.

In some embodiments, the plurality of demultiplexer computing nodes are individually configured as a smart network interface card comprising a memory for which access is obtained via a non-volatile memory express protocol.

In some embodiments, the demultiplexer computing node comprises a virtual instance corresponding to a smart network interface card and configured with a first predefined amount of random access memory and a second predefined amount of non-volatile memory express storage.

In some embodiments, the plurality of demultiplexer computing nodes initially store containers of data stream events in random access memory and subsequently persist the data stream events in the non-volatile memory express storage.

In some embodiments, the data stream is associated with the data stream and a sub-stream of the data stream.

In some embodiments, the control plane data is further associated with a sub-stream and the one or more containers are individually configured to store control plane data instances corresponding to a common stream identifier and one or more sub-stream identifiers that are associated with the common stream identifier.

In some embodiments, the method may comprise receiving, from a data client, a registration request indicating at least the stream identifier, and in response to the registration request, maintaining a record indicating that the data client is subscribed to the data stream corresponding to the stream identifier.

In some embodiments, the method may comprise 1) receiving, from a respective data client, a request for control plane data corresponding to a sequence number, 2) identifying, from the container metadata, a particular container that stores a corresponding control plane data event corresponding to the sequence number, 3) obtaining, from the particular container, the control plane data corresponding to the sequence number, and 4) providing, to the respective data client, the control plane data obtained from the particular container and corresponding to the sequence number.

In some embodiments, the one or more containers are associated with an active state or a closed state, and the one or more containers are restricted to enforce that only one container corresponding to the data stream is associated with the active state at any time.

In some embodiments, a single copy of the control plane data is stored within the one or more containers at any given time.

In some embodiments, the method may further comprise redistributing the control plane data event to one or more data plane clients according to the data stream and a sub-stream identified from the control plane data event.

In some embodiments, each of the plurality of demultiplexer computing nodes executes a respective data manager, the data manager being a key-value store manager. In some embodiments, the data manager maintains a container table comprising the container metadata.

At least one embodiment is directed to a cached log service of a cloud-computing environment. The cached log service may comprise one or more processors and one or more memories storing computer-executable instructions that, when executed by the one or more processors, cause the one or more processors to perform any of the methods disclosed herein.

At least one embodiment is directed to a cloud-computing system (“the system”). The system may comprise one or more processors and one or more memories storing computer-executable instructions that, when executed by the one or more processors, cause the one or more processors to perform any of the methods disclosed herein.

At least one embodiment is directed to a non-transitory computer-readable medium comprising executable instructions that, when executed by one or more processors associated with a cached log service, causes the one or more processors to perform any of the methods disclosed herein.

### BRIEF DESCRIPTION OF THE DRAWINGS

FIG. 1 is a simplified control path diagram showing cloud infrastructure components for attaching Block Storage Data Plane (BSDP) persistent storage, according to an embodiment.

FIG. 2 is a diagram showing a kernel architecture for implementing Internet Small Computer Systems Interface (iSCSI) and Non-Volatile Memory Express (NVMe) attachments, according to an embodiment.

FIG. 3 is a Non-Volatile Memory Express (NVMe) system diagram, according to an embodiment.

FIG. 4 is a diagram of a Non-Volatile Memory Express (NVMe)/Transmission control Protocol (TCP) target, according to an embodiment.

FIG. 5 is a simplified diagram of a smart network interface card (smartNIC) with Non-Volatile Memory Express (NVMe), according to an embodiment.

FIG. 6 is a diagram showing multipath handling in a smart network interface card (smartNIC), according to an embodiment.

FIG. 7 shows a diagram of an architecture for performing encryption/decryption with a smart network interface card (smartNIC), according to an embodiment.

FIG. 8 is a diagram of another example showing multipath handling in a smart network interface card (smartNIC), according to an embodiment.

FIG. 9 is a block diagram depicting a cloud-computing environment including a control plane and a data plane, according to at least one embodiment.

FIG. 10 is a block diagram depicting an environment that includes an example centralized cached log service, according to at least one embodiment.

FIG. 11 is a block diagram depicting an example demuxer, according to at least one embodiment.

FIG. 12 is a block diagram depicting an example flow for writing data corresponding to a stream and/or a sub-stream, according to at least one embodiment.

FIG. 13 is a block diagram depicting an example flow for reading data from an in-memory container, according to at least one embodiment.

FIG. 14 is a block diagram depicting an example flow for reading data from one or more in-memory containers, according to at least one embodiment.

FIG. 15 is a block diagram depicting an example method for utilizing in-memory containers, according to at least one embodiment.

FIG. 16 is a block diagram illustrating one pattern for implementing a cloud infrastructure as a service system, according to at least one embodiment.

FIG. 17 is a block diagram illustrating another pattern for implementing a cloud infrastructure as a service system, according to at least one embodiment.

FIG. 18 is a block diagram illustrating another pattern for implementing a cloud infrastructure as a service system, according to at least one embodiment.

FIG. 19 is a block diagram illustrating another pattern for implementing a cloud infrastructure as a service system, according to at least one embodiment.

FIG. 20 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to managing the distribution of control plane data to data plane clients of a cloud-computing environment. Control plane (CP) data is consumed by data plane (DP) clients. In legacy implementations, CP data was stored in data store that does not provide read scalability to serve DP clients directly. As a result, many services within the cloud-computing environment built custom distribution services to offload CP data into a middle-tier and used this middle-tier as a read end points for DP clients. DP clients usually number anywhere from hundreds of clients to hundreds of thousands of clients (smartNICs/VNIC as a service, etc.). These distribution services are redundant, difficult to maintain, and waste resources providing a custom service corresponding a cloud service. A centralized and scalable distribution service is desired which can be configured to store a stream of CP data events and provide a scalable read end point for DP clients. In some embodiments, this distribution service may provide a unified data store to solve unique problems related to distributing CP data events to DP components. In some embodiments, a cached log service may be implemented to provide the aforementioned functionality. The cached log service may, at least in part, be executed by one or more virtual instances that are configured as smart network interface cards (smartNICs).

In some embodiments, persistent memory (e.g., non-volatile random-access memory (NVRAM) or a solid-state drive (SSD) of a host machine) may be provided by a smart network interface card (smartNIC) operating at the host machine of a cloud computing environment. The persistent memory can be memory of the smartNIC or memory of the host machine on which the smartNIC executes that is accessible and managed by the smartNIC. This persistent memory can be utilized by the smartNIC to store input/output read and/or write operations received from an application running in a virtual machine (VM) or bare-metal (BM) instance of the host machine. The smartNIC may process data formatted according to an NVMe protocol and store the data locally or at non-volatile block storage at a NVMe target (e.g., a remote server such as a block storage data plane server of a block storage data plane of the cloud computing environment). In some embodiments, the data may be stored locally in containers that are specific to the data stream.

The disclosed techniques provide a number of advantages. By way of example, the disclosed techniques provide the ability to demultiplexing a single data stream into number of sub-streams while maintaining a single copy of the payload at the stream level and indexing sub-streams into this single copy of the payload. Additionally, the disclosed techniques enable a DP client to subscribe at the granularity of a stream or a stream+sub-stream and at a different points in time or different sequence numbers. The techniques described herein include bootstrapping a client from a cold start with snapshot isolation so that the DP client may be made consistent after the bootstrap process completes. The disclosed techniques include a key-value store that may be configured to store huge number of data stream events corresponding to any suitable number of stream ID and/or stream ID+sub-stream ID as well as an efficient ways to lookup a stream ID and/or stream ID+sub-stream ID at a particular sequence number.

### Non-Volatile Memory Express (NVMe) System Background

Creating and running a cloud service can include mounting and connecting persistent storage (e.g., a block storage data plane (BSDP) component) to cloud instances. The persistent storage can be created, using a console or application programming interface (API), and linked to cloud instances (e.g., a virtual machine (VM) host or a bare metal (BM) host machine running in the cloud). Linking, or attaching, persistent storage of a block storage data plane to a cloud instance can be performed using a communication protocol. The attached storage can communicate with the cloud instance's guest operating system (OS) using the protocol.

Connections between a cloud instance and persistent storage within the block storage data plane (“BSDP persistent storage,” for brevity) are flexible and a number of configurations are possible. For instance, the BSDP persistent storage can be attached to one or more cloud instances simultaneously. The data in the BSDP persistent storage is durable and the storage can retain data after an attachment to a cloud instance is removed. Data can be migrated between instances by detaching BSDP persistent storage from one cloud instance and attaching the BSDP persistent storage to a second instance.

Durable BSDP persistent storage can allow for instance scaling. A cloud instance can be deleted without destroying or reformatting the corresponding BSDP persistent storage. After the cloud instance is deleted, the BSDP persistent storage can be attached to a new instance. The new instance can be created with a different instance type or shape. For example, the new cloud instance can be a VM or a BM regardless of the deleted instance's type. Additionally, the number of cores in a cloud instance can be changed by deleting an initial instance and creating a new instance with a different number of cores.

A transfer of data through an attachment can be started with an endpoint called an initiator. Data can be sent from the initiator to an endpoint of the BSDP persistent storage that can receive data. This endpoint is referred to as “a target.” An agent can set up the target to receive data and forward the data to the target. A number of advantages can be provided by locating the initiator in a smart network interface card (smartNIC). A user may need to provide login information or other configuration from the cloud instance if the initiator is located in the instance. Additionally, it can be difficult to keep the initiator functional across different guest OS types and OS versions. Locating the initiator in the smartNIC can also free customer resources that would be used to run the initiator.

Attachments can be provided using storage networking standards including Internet Small Computer Systems Interface (iSCSI), paravirtualized (PV) iSCSI, and Non-Volatile Memory Express (NVMe). iSCSI can provide attachments for bare metal (BM) devices with the initiator running from inside a customer instance. The initiator for PV iSCSI attachments can be set up and run inside a cloud instance's hypervisor, and PV iSCSI attachments can be limited to running on virtual machines (VM). The initiator for NVMe attachments can be run on a smartNIC. Accordingly, NVMe attachments can provide attachments for both VM and BM networks.

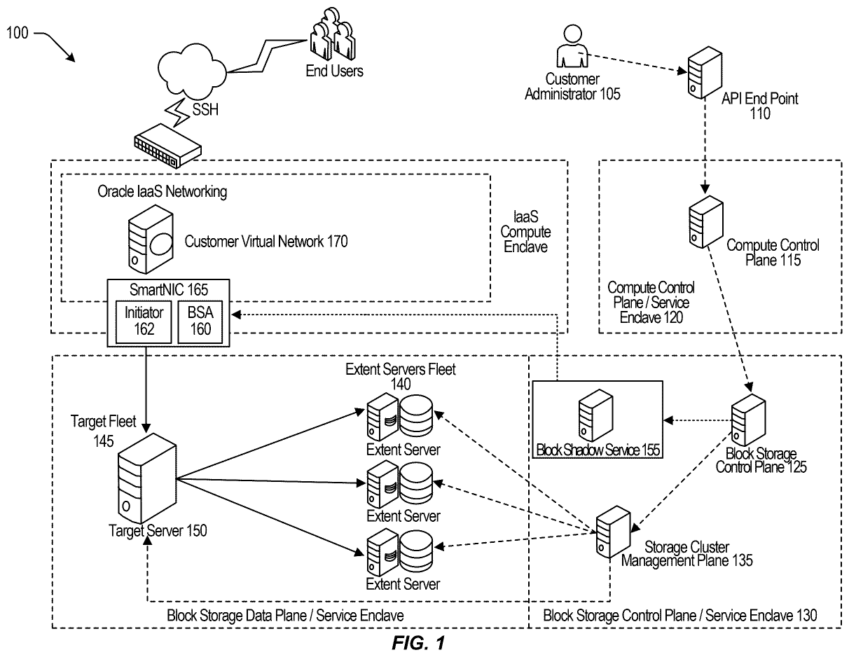

FIG. 1 is a simplified control path diagram 100 showing cloud infrastructure components for attaching BSDP persistent storage, according to an embodiment, for example, using NVMe. A customer administrator 105 can submit a request for a new storage attachment at an application programming interface (API) endpoint 110. In some examples, the customer administrator 105 may be any entity that manages or otherwise administers the use of cloud instances for a customer of the cloud service. In some instances, the API endpoint 110 may be an interface where customer's (e.g., customer administrator 105) can access the cloud service resources, for example, by making requests to have operations performed by the cloud service on resources managed for the customer. The request can be forwarded to the compute control plane 115 in a compute control plane service enclave 120. In some instances, compute control plane 115 can be a series of APIs that can provision, manage, reconfigure, or terminate resources based on user requests. The request can be forwarded from compute control plane 115 to the block storage control plane 125 in the block storage control plane 130. In some examples, the block storage control plane 125 can be a series of APIs that can provision, manage, reconfigure, or terminate block storage.

A request that is received at block storage control plane 125 can be forwarded to the storage cluster management plane 135. Storage cluster management plane 135 can manage server fleets, and, for example, storage cluster management plane 135 can manage extent server fleet 140 and target server fleet 145. In some examples, storage cluster management plane 135 can configure and monitor extent servers fleet 140 or target server fleet 145, and extent server fleet 140 can include servers storing striped and encrypted customer data. Extent server fleet 140 may be an example of BSDP persistent storage. Volumes can be striped across multiple extent servers in extent server fleet 140. Extent servers can be part of a block storage data plane service that handles extent-level I/O and stores the data for replication. In response to the request, storage cluster management plane 135 can identify at least one target server 150 in the target server fleet 145 as a target server for the attachment (e.g., a target server to which initiator 162 is to connect). In some instances, target server 150 can be a server that manages the flow of customer data to and from extent server fleet 140. Target server 150 can accept I/O requests from an NVMe initiator (e.g., initiator 762) operating at smartNIC 165 and send the requests to extent server fleet 140. The storage cluster management plane 135 can select the target server 150 based at least in part on the load experienced by the servers in the target server fleet 145, or the expected volume for the attachment. Storage cluster management plane 135 can forward information about the new attachment to the selected target server 150 or the extent server fleet 140. The information can identify one or more target servers that are able to receive traffic from the new attachment.

The request can be forwarded from block storage control plane 125 to the block shadow service 155. The block shadow service 155 can act as an agent, and block shadow service 155 can communicate with the Block SmartNIC Agent (BSA) 160 in smartNIC 165. In some examples, smartNIC 165 can be hardware that can connect the customer virtual network 170 to other computer networks. BSA 160 can serve as a communication link between block shadow service 155 and an NVMe agent in smartNIC 165. Communication from the block shadow service 155 can provide information about the target server and the attachment to BSA 160. A connection between the customer virtual network 170 and target server fleet 145 can be established by BSA 160. BSA 160 can expose a namespace to the host through host PCIe connection, which can be accessed by the host applications and by the customer through the customer virtual network 170. The customer virtual network 170 can be set up by the VCN, and traffic from customer virtual network 170 can reach extent servers fleet 140 via target server fleet 145 through smartNIC 165.

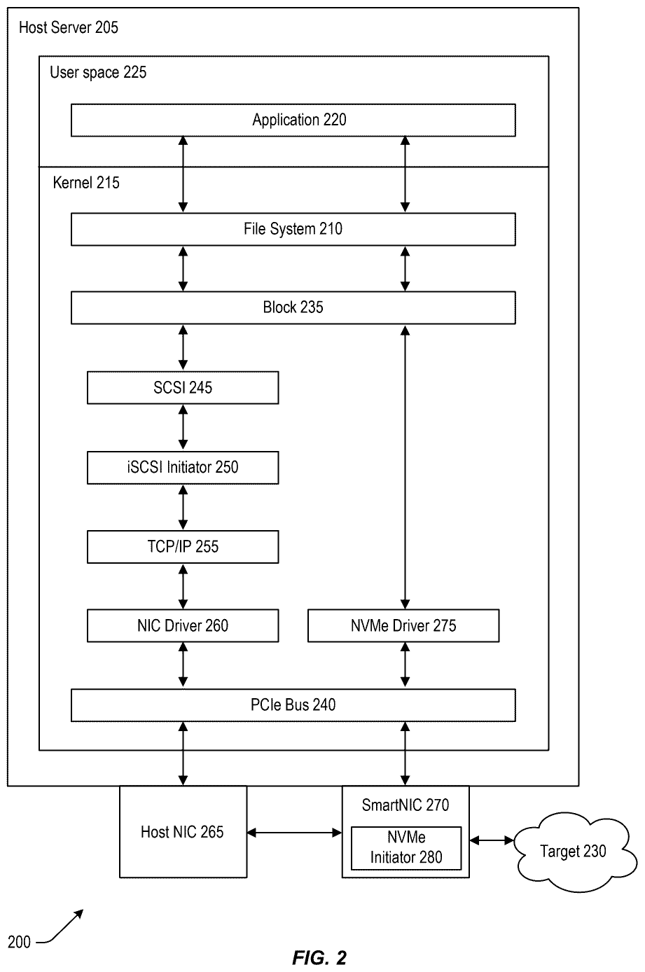

FIG. 2 is a diagram 200 showing a kernel architecture for implementing Internet Small Computer Systems Interface (iSCSI) and Non-Volatile Memory Express (NVMe) attachments according to an embodiment. NVMe and iSCSI are networking protocols providing block-level storage access, and both NVMe and iSCSI can be used to attach BSDP persistent storage. One difference between the two standards is that, in an iSCSI architecture, Input/Output (I/O) requests reach a smartNIC via a host network interface card (NIC), and, in an NVMe architecture, the smartNIC is directly connected to a Peripheral Component Interconnect Express (PCIe) bus. The NVMe kernel stack can be streamlined compared to the iSCSI stack, and NVMe's simplified architecture can be achieved because the NVMe initiator (e.g., initiator 162 of FIG. 1) can be located in the smartNIC 270.

In a host server 205, using either networking protocol, traffic can reach a file system 210 in the kernel 215 from an application 220 in the user space 225. The traffic can be addressed to a target 230 that can be a block storage server (e.g., target server fleet 145, extent servers fleet 140, etc.). Traffic for the two standards can follow similar pathways until the traffic arrives at block 235 from file system 210.

Using iSCSI, traffic from block 235 reaches the PCIe bus 240 via SCSI 245, iSCSI initiator 250, TCP/IP 255, and the NIC driver 260. iSCSI traffic leaving PCIe bus 240 can reach the target via host NIC 265 and smartNIC 270. In some instances, PCIe bus 240 can be a serial computer expansion bus. The NVMe pathway can follow a different pathway, and NVMe traffic can reach PCIe bus 240 from block 235 via NVMe driver 275. Instead of passing through host NIC 265, NVMe traffic can travel from PCIe bus 240 to smartNIC 270 before reaching target 230. The NVMe initiator 280 can be located in smartNIC 270 instead of being located in kernel 215 like iSCSI initiator 250.

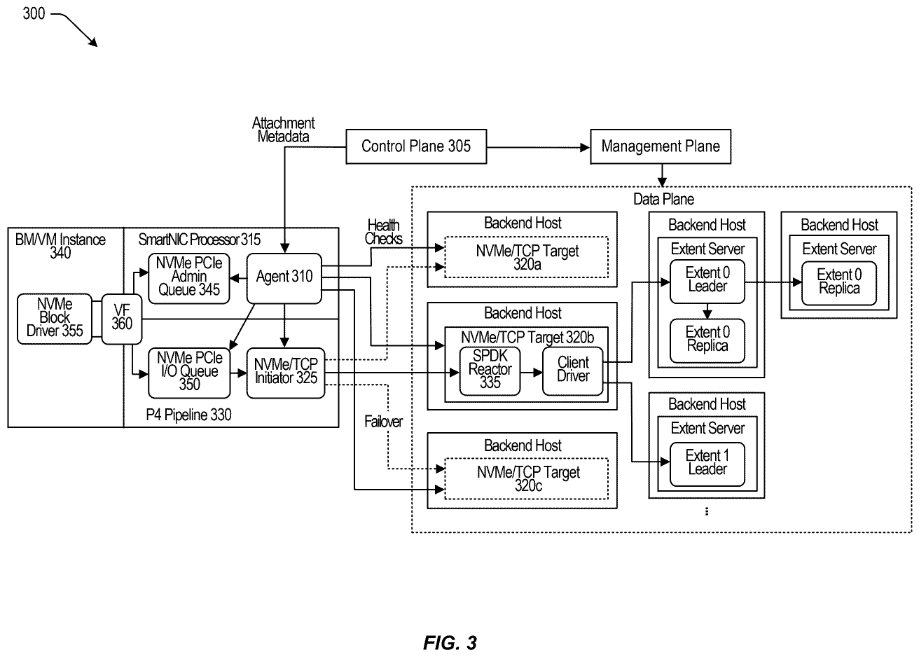

FIG. 3 is a Non-Volatile Memory Express (NVMe) system diagram 300 according to an embodiment. A customer, such as customer administrator 105, can initiate an NVMe attachment request from the console or a public API (e.g., API endpoint 110). The NVMe attachment request can be forwarded from the control plane 305 (e.g., block storage control plane 125) to an agent 310 (e.g., BSA 160) in the smartNIC processor 315. The agent 310 can perform health checks on NVMe/TCP targets 320a-320c to identify healthy targets, and agent 310 can instruct the NVMe/TCP initiator 325 in the Programming Protocol-Independent Packet Processors (P4) pipeline 330 to establish a connection with a healthy NVMe/TCP target (e.g., NVMe/TCP target 320b). P4 is a domain-specific programming language that is optimized for controlling packet forwarding. NVMe/TCP initiator 325 can communicate with Storage Performance Development Kit (SPDK) reactor 335 to initiate the connection (e.g., a NVMe/TCP connection). An NVMe/TCP connection refers to a TCP connection with which data provided according to an NVMe protocol that is wrapped/bound to a TCP message-based fabric.

Once a connection is established with NVMe/TCP target 320b and the NVMe attachment is completed, virtual machine/bare metal (VM/BM) instance 340 can issue NVMe admin commands or NVMe I/O commands to the NVMe/TCP target 320b. The NVMe commands can be issued from VM/BM instance 340 to NVMe PCIe admin queue 345 or NVMe PCIe I/O queue 350 via NVMe block driver 355 and virtual function (VF) 360. In some examples, VF 360 can be a PCIe function that supports single root I/O visualization (SR-IOV). In some instances, the admin queue can be used to establish host-controller associations and the queue can support commands like Identify, Get/Set Features, etc. Agent 310 can retrieve NVMe admin commands from the NVMe PCIe admin queue 345 and forward those commands to NVMe/TCP target 320b via a TCP connection using an NVMe specification that maps an NVMe storage access and transport protocol to message-based fabrics using TCP, or the commands can be processed locally. I/O commands received from VM/BM instance 340 can be enqueued into NVMe PCIe I/O queue 350. NVMe block driver 355 (e.g., NVMe driver 275) can retrieve the enqueued commands from NVMe PCIe I/O queue 350 to NVMe/TCP target 320b via NVMe/TCP initiator 325.

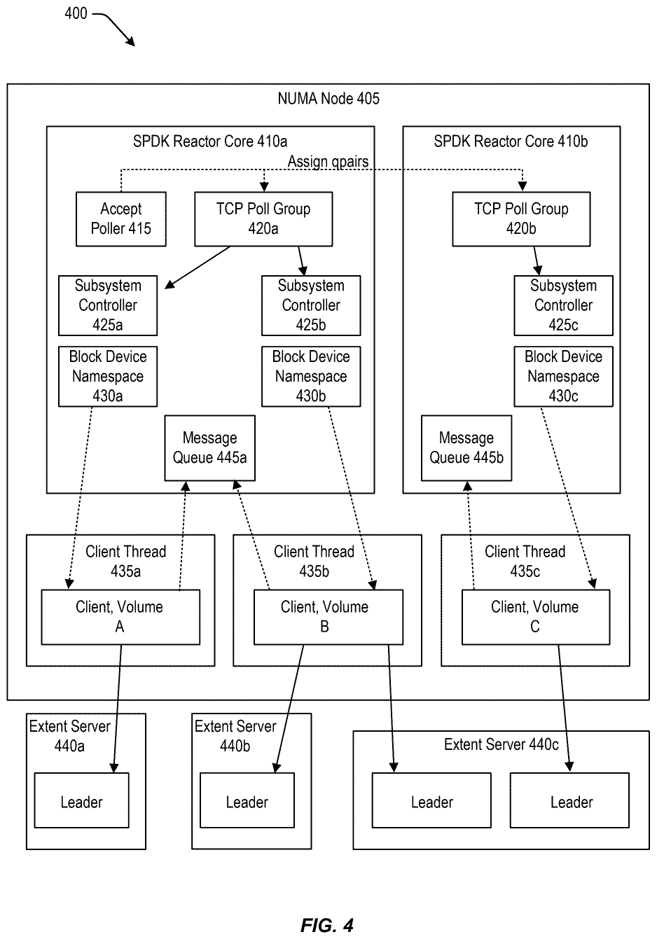

FIG. 4 is a diagram 400 of a Non-Volatile Memory Express (NVMe)/Transmission Control Protocol (TCP) target according to an embodiment. The NVMe/TCP target (e.g., NVMe/TCP target 320b) can be a Non-Uniform Memory Access (NUMA) node 405 that can include a central processing unit coupled with memory. Cores in the NUMA node 405 CPU can be assigned to one or more SPDK reactor cores such as SPDK reactor cores 410a-410b (e.g., SPDK reactor 335). Accept poller 415 can accept new connections to the SPDK reactor and assign the new connections to a SPDK reactor core (e.g., SPDK reactor core 410a). Accept Poller 415 can assign new connections to an available TCP poll group 420a-b in an available SPDK reactor core 410a-410b, and the new connections can be assigned using a round robin algorithm.

Subsystem controllers 425a-c can be assigned to a new connection, and, for example, subsystem controller 425a can be assigned for a connection made with TCP poll group 420a. More than one subsystem controller 425a-c can be assigned to one of the TCP poll groups 420a-b, and, for instance, subsystem controller 425a and subsystem controller 425b can be assigned to TCP poll group 420a. Block device namespaces 430a-430c can be generated when a connection is made with one of the subsystem controllers 425a-c.

Threads in a NUMA node CPU can be assigned as client threads 435a-c by one of the block device namespaces. Block device namespaces 430a-430c can forward a request that is received through the new connection to one of the client threads 435a-c, and client threads 435a-c can decide which extent server 440a-440c should receive the data associated with the request. After completing the request, client threads 435a-c can send a response to message queue 445a-b to indicate that a request has been completed. Requests can be received at a SPDK reactor core 410a-410b from the smartNIC initiator (e.g., NVMe/TCP initiator 325, NVMe initiator 280, initiator 162, etc.) or a different initiator. Responses can be sent from one of the SPDK reactor cores 410a-410b to the smartNIC initiator or a different initiator.

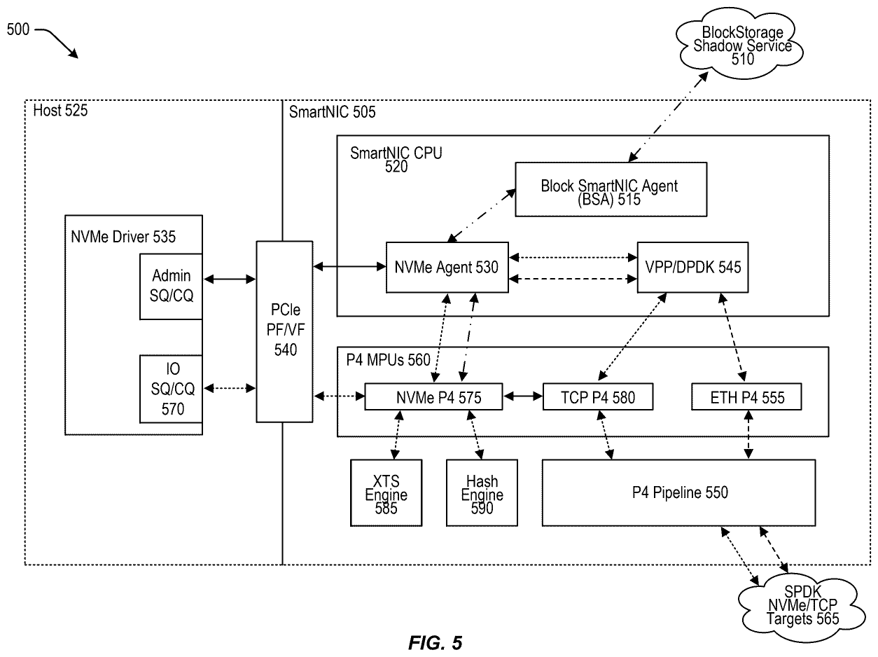

FIG. 5 is a simplified diagram 500 of a smart network interface card (smartNIC) with Non-Volatile Memory Express (NVMe) according to an embodiment. Requests can be received at smartNIC 505 from the block storage shadow service 510 (e.g., block shadow service 155) in the control plane (e.g., block storage control plane 125, control plane 305, etc.). The requests can be received at the Block SmartNIC Agent (BSA) 515 (e.g., BSA 160) running on the smartNIC central processing unit (CPU) 520. BSA 515 can serve a number of functions including performing health checks, ensuring that targets are available, or performing telemetry. BSA 515 forwards instructions or requests to the host 525, or other smartNIC components, via NVMe agent 530. Requests or instructions can be sent from NVMe agent 530 to the NVMe driver 535 via a PCIe physical function or virtual function (PF/VF) 540 (e.g., VF 360).

The NVMe agent 530 can establish a new I/O connection in response to a request from BSA 515 using the vector packet processing/data plane development kit (VPP/DPDK) module 545. The VPP/DPDK module can use a framework, such as VPP with the DPDK plugin, to process and route network packets. In some embodiments, the VPP/DPDK module can use another suitable packet processing framework or functionality different from the framework or functionality of vector packet processing using the DPDK plugin. Upon receiving a request from NVMe agent 530, VPP/DPDK 545 can send a request to the P4 pipeline 550 (e.g., P4 pipeline 330) via the Ethernet (ETH) P4 module 555 running on the P4 match protection unit (MPU) 560. P4 pipeline 550 can establish an I/O connection with SPDK NVMe/TCP targets 565 (e.g., target 230, target server fleet 145, NVMe/TCP target 320a-320c, etc.). Establishing a connection can include sending instructions to NVMe driver 535 or SPDK NVMe/TCP targets 565.

The I/O communication can be offloaded to a fast path I/O pipeline after an I/O connection is established with an SPDK NVMe/TCP target 565. The I/O fast path traffic can travel along the fast path pipeline from the I/O submission queue/completion queue (SQ/CQ) 570 in host 525 to P4 MPUs 560 via PCIe PF/VF 540. I/O traffic can be received in P4 MPUs 560 at NVMe P4 575 and forwarded to the SPDK NVMe/TCP targets 565 via TCP P4 580 and P4 pipeline 550. Traffic in I/O SQ/CQ 570 can start from the submission queue fand end at the completion queue when I/O completes. If traffic along the fast path pipeline fails, NVMe P4 575 or TCP P4 580 can inform NVMe agent 530 of the failure. NVMe agent 530 can be configured so that NVMe agent can create a new I/O connection in response to the failure and offload the new connection to the fast path pipeline. XTS engine 585 is an encryption engine that can encrypt user data using the xor-encrypt-xor (XEX)-based tweaked-codebook mode with ciphertext stealing (XTS) block cypher, and hash engine 590 can use cryptographic hash functions to verify data integrity.

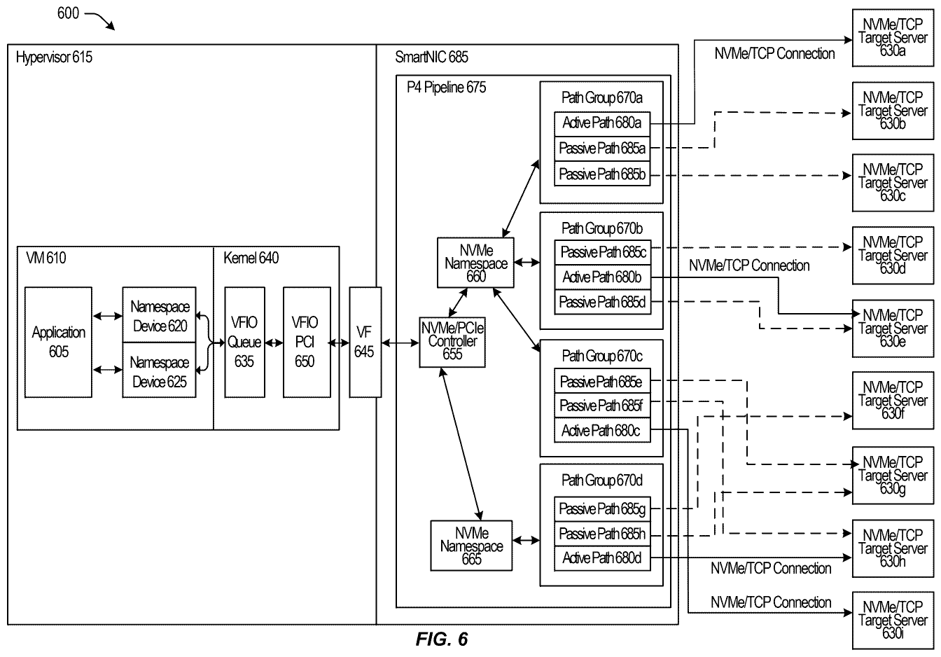

FIG. 6 is a diagram 600 showing multipath handling in a smart network interface card (smartNIC) according to an embodiment. An application 605 can run in a virtual machine (VM) 610 managed by a hypervisor 615. Application 605 can be similar to application 220, and VM 610 can be a bare metal machine (e.g., VM/BM instance 340). Two namespace devices, namespace device 620 and namespace device 625, can be associated with Application 605. A namespace can be a NVMe storage that is formatted for block access. A namespace can be analogous to a logical unit in SCSI, and a block storage volume can be a single namespace. Traffic between namespace device 620 or namespace device 625 and the NVMe/TCP target servers 630a-i (e.g., target server 150) can be received via the virtual function Input/Output queue (VFIO) 635 in the kernel 640. The virtual function (VF) 645 can be connected to VFIO queue 635 via the VFIO peripheral component interconnect (PCI) 650. VF 645 can be a virtual function or a physical function.

The NVMe/PCIe controller 655 (e.g., NVMe P4 1575) can route traffic from the namespace devices 620 and 625 to NVMe namespaces. For instance, traffic can be routed between namespace device 620 and NVMe namespace 660, and traffic can be routed between namespace device 625 and NVMe namespace 665. The NVMe namespaces can be associated with one or more path groups 670a-d located in the P4 pipeline 675 (e.g., P4 pipeline 550, P4 MPUs 560, etc.) in smartNIC 680 (e.g., smartNIC 165, smartNIC 270, smartNIC 505, etc.). For instance, NVMe namespace 660 can route traffic to path groups 670a-670c, and NVMe namespace 665 can route traffic to path group 670d.

Path groups can include an active path 680a-d and one or more passive paths 685a-685h. Active paths 680a-d or passive paths 685a-685h can be associated with a NVMe/TCP target server 630a-i. Traffic between a NVMe/TCP target server 630a-i and namespace device 620 or namespace device 625 can be routed via active paths 680a-d. NVMe/TCP target servers 630a-i can route traffic to and from extent servers (e.g., extent servers fleet 140, extent servers 440a-440c, etc.).

Traffic can be routed via a passive path 685a-685h if an active path 680a-d fails. In response to a failure, data associated with passive path 685a-685h can be used (e.g., NVMe agent 530, initiator 162, etc.) to login to an extent server via NVMe/TCP target servers 630a-630h. The extent server can change a token from the token associated with an active path 680a-d to a token associated with a passive path 685a-685h. The extent server can use the token to determine whether to accept traffic from a path (e.g., active paths 680a-d or passive paths 685a-685h).

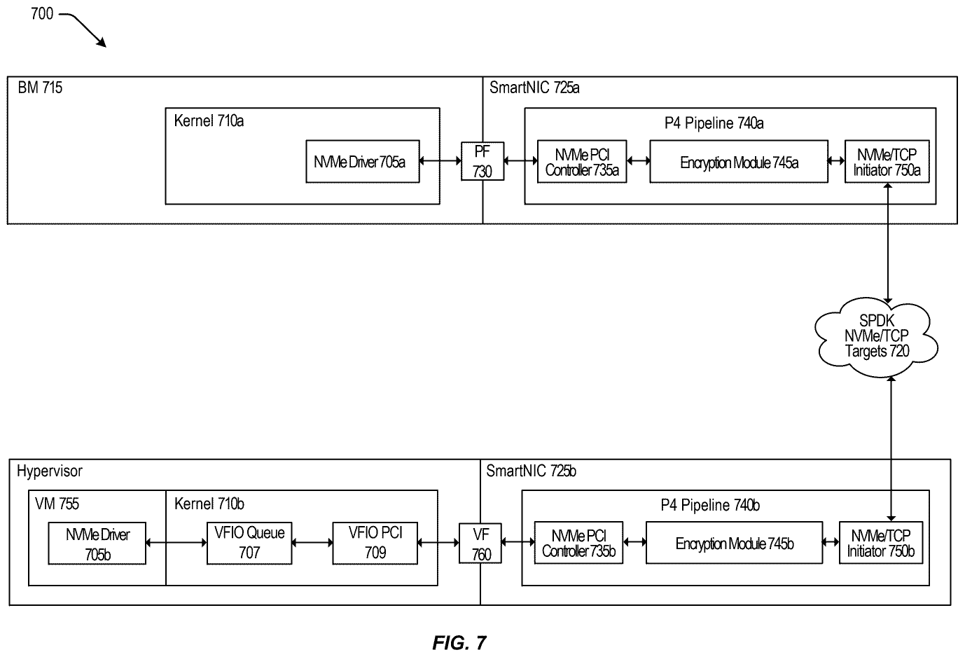

FIG. 7 shows a diagram of an architecture 700 for performing encryption/decryption with a smart network interface card (smartNIC) according to an embodiment. The architecture 700 can provide a unified means for encrypting/decrypting both VM and BM traffic. NVMe driver 705a (e.g., NVMe driver 275) can run in the kernel 710a of a bare metal (BM) machine 715 (e.g., VM/BM instance 340, etc.). Traffic can be sent from NVMe driver to SPDK NVMe/TCP targets 720 via smartNIC 725a. The BM traffic can be received via a physical function (PF) 730 (e.g., PCIe PF/VF 540, etc.) at the NVMe PCI controller 735a (e.g., NVMe/PCIe controller 655, NVMe P4 575, etc.) in the P4 pipeline 740a (e.g., P4 MPUs 560, P4 pipeline 550, etc.).

Outgoing BM traffic traveling from NVMe driver 705a to SPDK NVMe/TCP targets 720 can be encrypted by the encryption module 745a in smartNIC 725a, and incoming BM traffic can be decrypted by the encryption module 745a. Encryption module 745a can encrypt or decrypt traffic using an encryption algorithm such as Advanced Encryption Standard (AES). The encrypted BM traffic can be sent to SPDK NVMe/TCP targets 720 via the NVMe/TCP initiator 750a (e.g., NVMe initiator 280, NVMe/TCP initiator 325, NVMe agent 530, etc.). Incoming encrypted BM traffic from SPDK NVMe/TCP targets 720 can be received at NVMe/TCP initiator 750a before being forwarded along the pathway to NVMe driver 705a. Incoming encrypted BM traffic can be decrypted by the encryption module 745a.

Outgoing VM traffic can be sent from NVMe driver 705b in the virtual machine (VM) 755 (e.g., VM/BM instance 340, VM 610, etc.) to the virtual function Input/Output (VFIO) Queue 707 (e.g., VFIO queue 635) in kernel 710b and on to a virtual function (VF) 760 (e.g., VF 360, VF 645, etc.) via a VFIO PCI 709 (e.g., VFIO PCI 650). The outgoing VM traffic can be forwarded to NVMe PCI controller 735b (e.g., NVMe/PCIe controller 655, NVMe P4 575, etc.) in the P4 pipeline 740b (e.g., P4 MPUs 560, P4 pipeline 550, etc.). The outgoing VM traffic can be forwarded from smartNIC 725b to SPDK NVMe/TCP targets 720 via encryption module 745b and NVMe/TCP initiator 750b (e.g., NVMe initiator 280, NVMe/TCP initiator 325, NVMe agent 530, etc.). Incoming VM traffic from SPDK NVMe/TCP targets 720 can be received at NVMe/TCP initiator 750b (e.g., NVMe initiator 280, NVMe/TCP initiator 325, NVMe agent 530, etc.) before the incoming traffic is forwarded along the pathway to NVMe driver 705b. Incoming encrypted VM traffic can be decrypted by the encryption module 745a.

### Load-Based NMVe Over TCP Connection Management

Block input/output operations, including read operations and write operations, may be issued by the operating system at a VM or BM, and sent through an NVMe PCIe interface by a NVMe driver. Input/output operations may be sent though an NVMe P4 pipeline and may be transported a remote block storage backend using an NVMe over fabric (e.g., TCP/IP) protocol. The transport and processing of input/output operations through the fabric/network costs extra time, which is observed as added end-to-end latency. Extra delays that are introduced by packet drop or re-transmission are experienced as latency jittering to the host. Thus, users who run latency sensitive applications usually choose compute shapes with local solid-state drives to get the lowest latency with minimum jitters. However, there are a few shortcomings of using local SSDs. First, local SSDs do not provide the managed service that remote block storage service provides, which include replication based availability guarantees, and backup/restore services. Additionally, local SSDs are dedicated resource that are not as cost-effective as remote block storage service, which charges based on user demands. In addition, the size of local SSDs is usually fixed, and may not be flexible enough to satisfy the user's need. In contrast, remote block storage provides online resizing capability so user's can grow the volume dynamically based on demand.

The persistent storage techniques discussed in the following figures take advantage of both local storage and remote block storage service for an NVMe over TCP (“NVMeOTCP”) attachment. By equipping the smartNIC with a local persistent memory (or at least persistent memory at the host machine), we are able to use it as a cache for block input/output operations to improve latency and jitters. The persistent memory could be in a form of local SSD that is plugged in as PCIe device to the SmartNIC, or an integrated NVRAM or NVDIMM, etc. Meanwhile, remote block storage may be working as a relatively slower backup persistent layer managed service to provide replication based availability guarantees and backup/restore services. In some embodiments, multiple persistent memory storage devices can be utilized for the persistent storage managed by the smartNIC (e.g., using any suitable combination of SSD(s) of the host device and/or NVRAM(s) and/or NVDIMM(s) of the smartNIC) to provide replication and backup/restore capabilities of the data cached by the smartNIC. The aforementioned techniques are described in more detail in the following figures.

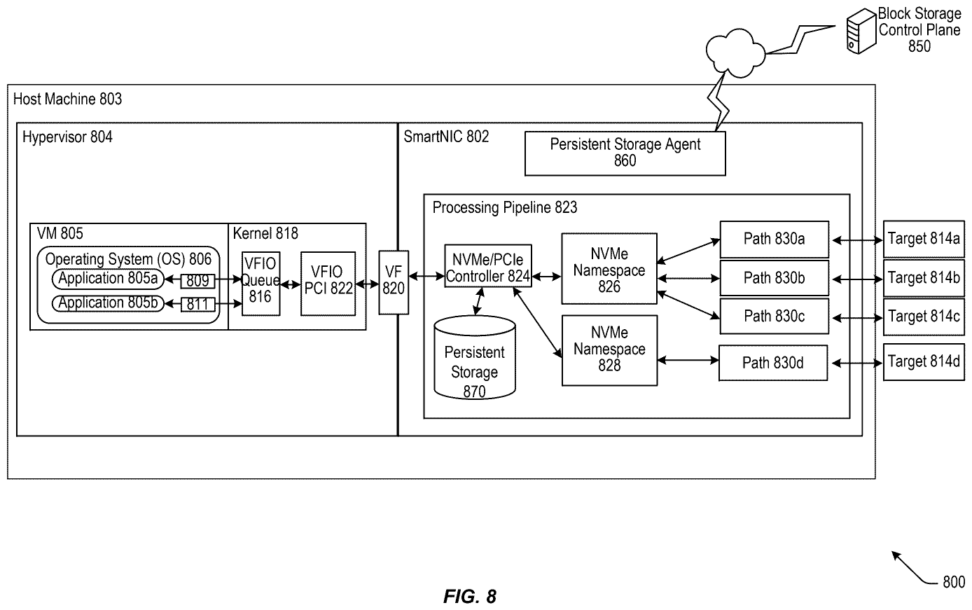

FIG. 8 is a diagram 800 showing another example of multipath handling in a smart network interface card (smartNIC) 802 (e.g., smartNIC 685 of FIG. 6), according to an embodiment. The smartNIC 802 may be part of a host machine (e.g., host machine 803) of a cloud computing environment on which hypervisor 804 executes. Hypervisor 804 may be configured to manage one or more virtual machines (e.g., VM 805) hosted by the host machine. Each VM may be a virtual machine, or a bare metal instance can be similarly utilized in lieu of a VM to the examples provided herein. One or more applications can run at each of the VMs (e.g., VM 805) at an operating system of the VM. By way of example, applications 805a and 805b may execute within operating system (OS) 806 at VM 805. Applications 805a and 805b may be similar to application 220, 605, etc. VM 805 and applications 805a and 805b may be associated with a particular tenant/customer of a cloud computing environment while other VMs and/or applications may be associated with the same or different tenant/customer. Applications 805a and/or 805b may be configured to send and receive data to and from a corresponding block storage data plane (BSDP) component. For example, application 805a may be configured to transmit and receive data through processing pipeline 823 to a BSDP volume associated with a first namespace. Likewise, application 807b may be configured to transmit and receive data through processing pipeline 823 to a BSDP volume associated with a second namespace.

Namespace device 809 and namespace device 811, which are examples of namespace device 620 and namespace device 625, can be associated with each application (e.g., application 805a and 805b, respectively). In some embodiments, an application may provide data corresponding to multiple namespaces. Therefore, multiple namespace devices may be utilized with a single application. A namespace may be associated with a non-volatile memory (NVM) storage that is formatted for block access. By way of example, a given namespace may be associated with a particular block storage volume of a block storage data plane of a cloud computing environment (e.g., the block storage data plane (BSDP) of FIG. 1, including extent servers fleet 140, one or more of which may be configured to provide a block storage volume/persistent storage within the BSDP). A namespace can be analogous to a logical unit in SCSI, and a block storage volume can be associated with a single namespace. Traffic may be routed along the path from application 805a, through namespace device 809, to NVMe namespace 826 and on to NVMe/TCP target servers associated with the same namespace (e.g., targets 814a-c, examples of the target server fleet 145). Each of the targets 814a-c may serve as an endpoint that manages data receipt and/or transmissions that utilize TCP connections that are associated with the same namespace. Target 814d may serve as an endpoint that manages data receipt and/or transmissions that utilize TCP connections that associated with another namespace and corresponding block storage volume. In some embodiments, each of targets 814a-d are configured to receive data from a single and unique path for which the other endpoint corresponds to a unique IP address associated with the smartNIC. In some embodiments, each of targets 814a-d are configured to receive data from a single and unique path for which the other endpoint corresponds to a unique IP address associated with the smartNIC. Data received from the applications may be provided to the virtual function Input/Output queue (VFIO) 816 (e.g., the VFIO queue 635) in kernel 818 (an example of kernel 640). The virtual function (VF) 820 (an example of VF 645) may be connected to VFIO queue 816 via the VFIO peripheral component interconnect (PCI) 822 (an example of the VFIO PCI 650). VF 820 can be a virtual function or a physical function.

Processing pipeline 823 may include NVMe/PCIe controller 824, NVMe namespaces 826 and 828, and paths 830a-d. The NVMe/PCIe controller 824 (an example of NVMe P4 1575, NVMe/PCIe controller 655, etc.) may route traffic from the namespace devices 809 and 811 to NVMe namespaces 826 and 828, respectively. For instance, traffic can be routed between namespace device 809 and NVMe namespace 826, and traffic can be routed between namespace device 811 and NVMe namespace 828. The NVMe namespaces can be associated with one or more paths (e.g., paths 830a-d, collectively referred to as “paths 830”). Each path 830a-d may correspond to one or more active or passive network paths (“active paths” or “passive paths,” for brevity). Each of the paths 830 may include a single active path. In some embodiments, the paths 830a-d may individually correspond to a path group described in connection with FIG. 6 that may include a single active path and two passive paths. Each of the active and/or passive paths of paths 830 may be individually associated with a unique IP address assigned to the smartNIC. Each smartNIC IP address for a given path (path 830a) may differ from the smartNIC IP addresses used for the other paths (paths 830b-d) of paths 830.

The paths 830a-d may individually be associated with a namespace corresponding to a particular BSDP volume (e.g., BSDP persistent storage). As depicted, paths 830a-c are associated with a namespace with which targets 814a-c are also associated (e.g., NVMe namespace 826). As another example, path 830d may be associated with a namespace with which target 814d is associated (e.g., NVMe namespace 828). Targets 814a-c may receive data via paths 830a-c intended for a particular BSDP volume/persistent storage. Targets 814a-c may transmit data from the BSDP volume/persistent storage along paths 830a-c to ultimately provide data to application 805a. Similarly, target 814d may receive data via path 830d intended for another BSDP volume/persistent storage. Target 814d may transmit data from the BSDP volume/persistent storage along path 830d to ultimately provide data to application 805b.

The number of paths corresponding to a particular BSDP volume/persistent storage may be identified based at least in part on a performance threshold associated with the BSDP volume/persistent storage. By way of example a particular BSDP volume may be associated with a performance threshold that indicates the BSDP volume can process up to 2 million input/output operations per second (IOPS). Each of the paths 830a-d may be associated with a performance capability indicating the maximum IOPS each path can sustain. In some embodiments, the performance capability of a path is the same for every path (e.g., 60,000 IOPS). In some embodiments, block storage control plane 850 (an example of the block storage control plane 125) may be configured to identify a total number of active paths of a given performance capability (60,000 IOPS) needed to meet the performance threshold associated with the BSDP volume (2 million IOPS). The particular number of paths 830 depicted in FIG. 8 is not intended to limit the scope of this disclosure. A greater or fewer number of paths may be utilized. Configuration information may be provided by the block storage control plane (BSCP) 850 to an agent executing at the smartNIC 802 (e.g., BSA 160, agent 310, BSA 515, etc., not depicted here) which in turn may utilize the process discussed in connection with FIG. 5 to establish TCP connections corresponding to every active path. The agent may refrain from having TCP connections for passive paths established while the passive paths are designated as being passive. The agent may change paths from active to passive, and vice versa, at any suitable time based on, for example, network conditions.

SmartNIC 802 may include persistent storage agent 860. Persistent storage agent 860 may be an example of BSA 160, agent 310, BSA 515, etc. The persistent storage agent 860 may be a software agent executed by the processor(s) of SmartNIC 802 (e.g., smartNIC CPU 520). The persistent storage agent 860 may be configured to receive configuration parameters from the BSCP 850. Configuration parameters (also referred to as “configuration data”) may include a mode indicator. In some embodiments, the mode indicator may indicate usage policies for a persistent storage of the smartNIC 802 (e.g., persistent storage 870). The mode indicator may indicate a first mode corresponding to utilizing the persistent storage at the host machine for both read operations and write operations, a second mode (e.g., a “passthrough mode” indicating that the persistent storage at the host machine is not to be used for read operations and write operations, a third mode indicating that the persistent storage at the host machine is to be used for only write operations, and a fourth mode for only read operations. In some embodiments, the usage policies may be provided as part of the configuration data and used to configure system to use the persistent storage 870 in accordance with the usage policies.

In some embodiments, the freshness of the remote block storage volume can also be configured based on the configuration data provided to the persistent storage agent 860 and subsequent use of the persistent storage 870. By way of example, a threshold value may be provided within the configuration data to limit a write buffer size for the persistent storage 870. This threshold value may be used to ensure the amount of data written to the persistent storage 870 due to processing write operations by the smartNIC does not reach a size that exceeds the threshold value.

As depicted, persistent storage 870 may be in memory at the smartNIC 802. However, in some embodiments, persistent storage 870 may be a local storage device of the host machine, which is accessible to the smartNIC 802. In some embodiments, persistent storage 870 may include multiple storage devices, any combination of which may be local to the smartNIC or the host machine, which provide data replication and data recovery functionality similar to those provided at the block storage data plane. In some embodiments, persistent storage 870 may be configured to process over a threshold number of input/output operations per second (e.g., 2 million IOPS).

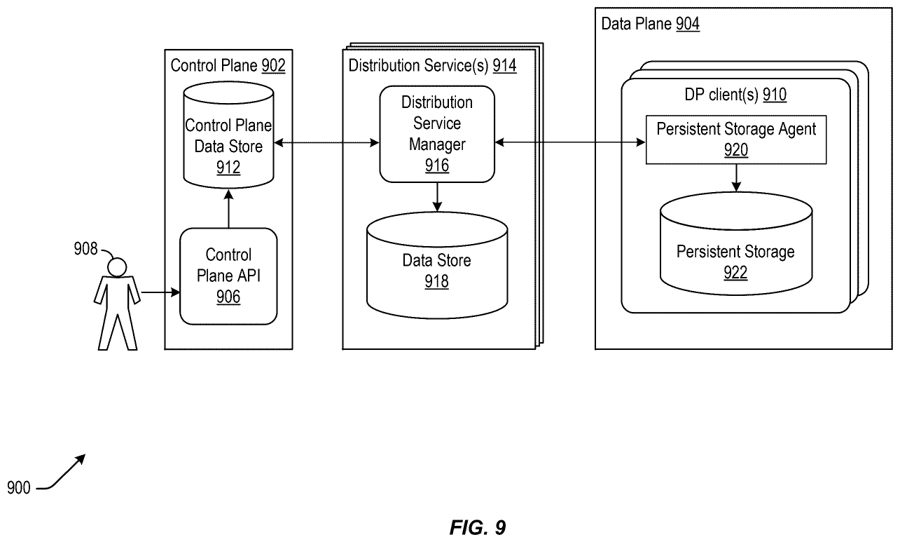

FIG. 9 is a block diagram depicting a cloud-computing environment 900, according to at least one embodiment. Cloud-computing environment 900 may include control plane 902 and data plane 904. The cloud-computing environment 900 may depict legacy implementations of distributing data to one or more data plane (DP) clients (e.g., DP client(s) 910).

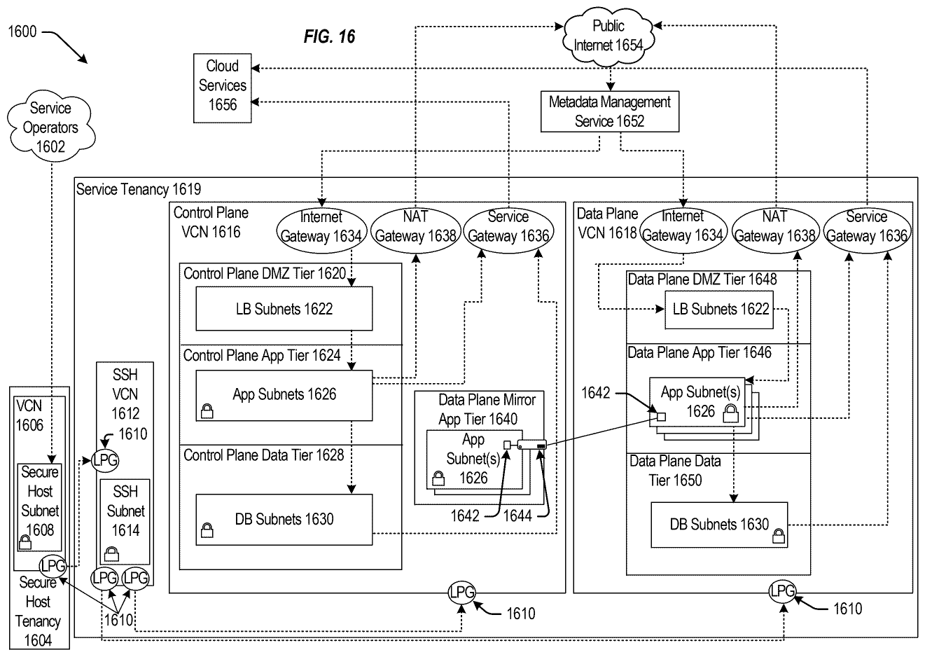

The control plane 902 may be responsible for accepting work requests that include intended state data that describes an intended state of a set of one or more data plane resources. For example, a work request may be received by control plane application programming interface (API) 906. The work request can be initiated by user 908 via a user device (not depicted) interfacing with a cloud-computing environment in which control plane 902 and data plane 904 operate. In some embodiments, control plane API 906 may be provided as part of one or more service(s) (e.g., one of cloud service 1656 of FIG. 16). Control plane API 906 may be configured to receive any suitable number of work requests corresponding to one or more data resources (e.g., a virtual machine, a smart network interface card, a cluster of virtual machines, etc.). In some embodiments, the work requests may be associated with DP client(s) 910. DP client(s) 910 may individually be an example of smartNIC 165 of FIG. 1. As depicted in FIG. 9, each DP client may include a persistent storage agent (e.g., persistent storage agent 920, BSA 160 of FIG. 1, an example of persistent storage agent 860 of FIG. 8, or the like) and persistent storage 922 (e.g., an example of persistent storage 870 of FIG. 8).

A work request may include, among other things, a request identifier and intended state data. The request identifier may uniquely identify the work request such that the work request can be distinguishable from other work requests. By way of example, the request identifier for a particular work request can be an alphanumeric string of characters of any suitable length that is unique to that work request and with which that work request can be identified. Intended state data may include any suitable number of parameters. These parameters may define attributes of a data plane resource to which DP client(s) 910 individually relate, but not limited to, an identifier for the resource, an availability domain, a shape corresponding to the node, a number of processing units of the resource, an amount of random access memory (RAM) of the resource, an amount of disk memory, a role (e.g., a data node, a master node, etc.), a status (e.g., healthy), or the like. In some embodiments, the control plane API 906 may be configured to store all received work requests in a data store (e.g., a distributed data store) configured to store such information (e.g., control plane (CP) data store 912).

In some embodiments, CP data store 912 may be configured to store work requests and/or an intended state data corresponding to an intended state of one or more data plane resources of data plane 904. In some embodiments, the CP data store 912 may be configured to store a mapping of one or more data plane identifiers of DP resource(s) with intended state data and/or current state data. Intended state data refers to data that specifies one or more aspects of a DP resource which has been requested and to which the DP resource is intended to be modified. Current state data (sometimes referred to as “actual state data”) corresponds to one or more parameters that identify one or more current aspects of a DP resource as currently operating.

As described above, a centralized data store (e.g., CP data store 912) may not provide read scalability that is sufficient to serve a large number of data plane clients (e.g., DP client(s) 910). DP client(s) 910 may often number anywhere between hundreds to hundreds of thousands data plane clients. Due to this deficiency, cloud service teams have previously developed customized distribution services (e.g., distribution service(s) 914) to offload control plane data into a middle tier data layer and use this middle tier data layer as an end point for data plane clients.

In legacy implementations, for example, distribution service(s) 914 may individually include a distribution service manager 916 that may be configured to poll CP data store 912 and copy current and/or intended state data to data store 918. In some embodiments, distribution service(s) 914 may individually be configured to push such data to a corresponding DP client of DP client(s) 910, or the individual DP client(s) 910 may be configured to poll for such data from distribution service(s) 914. This may include hard coding topics, keys, etc. with which data was published to the appropriate data clients. These customized distribution services (e.g., distribution service(s) 914) are difficult to develop, difficult to maintain and/or update, and duplicate functionality unnecessarily.

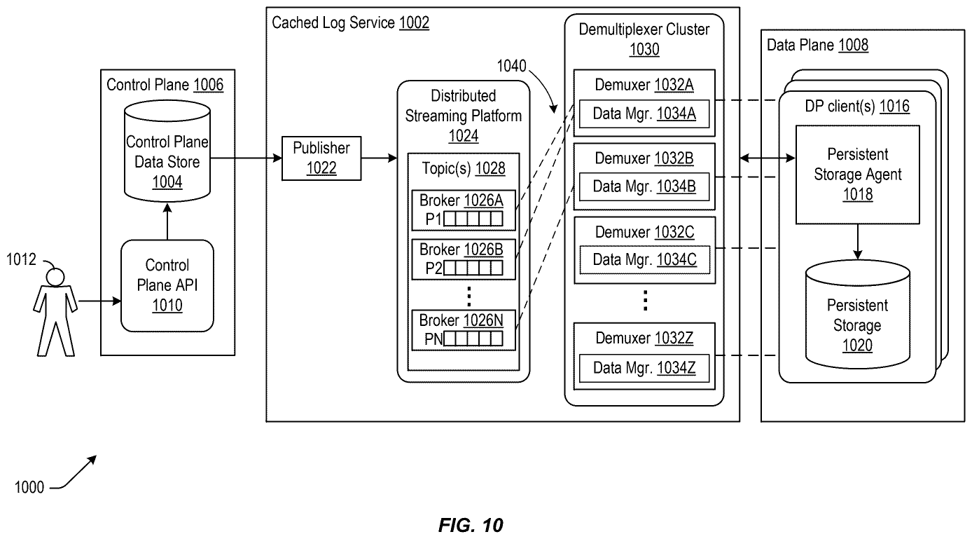

FIG. 10 is a block diagram depicting an environment 1000 that includes an example centralized cached log service (e.g., Cached Log Service (CLS) 1002), according to at least one embodiment. In some embodiments, CLS 1002 may be an example of a unified data store that solves the aforementioned difficulties related to control plane to data plane distribution. In some embodiments, CLS 1002 provides a scalable distribution service which can be configured to store streams of events obtained from control plane (CP) data store 1004 (an example of CP data store 912 of FIG. 9) of control plane 1006 (e.g., control plane 902 of FIG. 9) to components of data plane 1008.

As similarly discussed above in connection with FIG. 9, the control plane 1006 may be responsible for accepting work requests that include intended state data that describes an intended state of a set of one or more data plane resources. For example, a work request may be received by control plane application programming interface (API) 1010 (an example of control plane API 906 of FIG. 9). The work request can be initiated by user 1012 (e.g., user 908 of FIG. 9) via a user device (not depicted) interfacing with a cloud-computing environment in which control plane 1006 and data plane 1008 operate. In some embodiments, control plane API 1010 may be provided as part of one or more service(s) (e.g., one of cloud service 1656 of FIG. 16). Control plane API 1010 may be configured to receive any suitable number of work requests corresponding to one or more data resources (e.g., a virtual machine, a smart network interface card, a cluster of virtual machines, etc.). In some embodiments, the work requests may be associated with DP client(s) 1014 (an example of DP client(s) 910 of FIG. 9). DP client(s) 1016 may individually be an example of smartNIC 165 of FIG. 1. As depicted in FIG. 10, each DP client may include a persistent storage agent 1018 (e.g., persistent storage agent 920 of FIG. 9, of BSA 160 of FIG. 1, an example of persistent storage agent 860 of FIG. 8, or the like) and persistent storage 1020 (e.g., an example of persistent storage 870 of FIG. 8, an example of persistent storage 922 of FIG. 9, etc.).

CLS 1002 may be an example of a unified distribution service that may be configured to distribute CP updates. In some embodiments, CLS 1002 may be configured to publish events (e.g., CP updates) across services in a manner that allows each service to differentiate between data of interest versus data that is not of interest.

CLS 1002 may include publisher 1022. Publisher 1022 may be an example of a thin publisher. A “thin publisher” is intended to refer to a computing device or instance that is a simple, potentially low-performance computing device/instance that has been optimized to perform publishing tasks and little, if anything, else. In some embodiments, publisher 1022 may be configured to poll CP data store 1004 to obtain update logs and writes the update logs to distributed streaming platform (DSP) 1024. The data obtained from the update logs may include a composite key, a value, and a sequence number or the publisher 1022 may be configured to add any suitable portion of the composite key, value, or sequence number to an update retrieved from CP data store 1004. In some embodiments, generating and/or adding the composite key, value, or sequence number to an update may be performed based at least in part on a predefined scheme or rule set with which the publisher 1022 is configured. In some embodiments, the composite key may be in the form of a primary key (e.g., Stream Identifier (StreamID)) concatenated with secondary key (e.g., Sub-stream Identifier (Sub-streamID)), referred to as “StreamID+Sub-streamID.” Any suitable Sub-streamID may be associated with a given StreamID based at least in part on predefined data. In some embodiments, DP client(s) 1016 may be interested in consuming event data at a granularity of primary key and/or primary key+secondary key (e.g., a combination/concatenation of primary key and secondary key). In some embodiments, data client(s) 1016 may be interested in more than one StreamID and/or StreamID/Sub-streamID and the starting point of consumption could be based at least in part on sequence numbers.

DSP 1024 may be a distributed streaming platform that includes a computing cluster of computing devices/instances, including brokers 1026A-1026N (collectively, referred to as “broker(s) 1026”). An example of DSP 1024 may include Apache Kafka®. Brokers 1026 may form a storage layer of DSP 1024. DSP 1024 may be configured to receive events from one or more producers (e.g., publisher 1022) and organize and write those events to one or more topics (e.g., topic(s) 1028). In some embodiments, one or more consumers may register with DSP 1024 to receive events corresponding to topic(s) 1028. In some embodiments, topic(s) 1028 may be spread over a number of buckets (P1-PN, also referred to as “partitions”) across brokers 1026. This enables devices to both read and write data to/from many brokers at the same time. When an event is published by publisher 1022 to one of topic(s) 1028, the event may be appended to one of the topic's partitions (e.g., P1 of broker 1026A). Events that are associated with a common event key are written to the same partition. DSP 1024 may be configured to guarantee that any consumer of a given topic will always read that partitions events in the same order as they are written to the partition. The number of partitions included in each topic may be configurable at the time of creation. In some embodiments, DSP 1024 may be configured to split events corresponding to a StreamID into different partitions than events corresponding to a StreamID/Sub-streamID combination. As a non-limiting example, a StreamID may correspond to a single network topic/stream that is associated with 100,000 DP clients (e.g., 100,000 smartNICs), but an update to a particular virtual local area network (VLAN) may only relate to 1,000 DP clients (e.g., 1,000 smartNICs). StreamID and Sub-streamID may be used to demultiplex (also referred to as “demuxing”) the stream from CP data store 1004 into multiple streams. Demultiplexing refers to a process of separating a data stream into different outputs.

In some embodiments, DSP 1024 may be configured to receive data from publisher 1022 according to a first distribution scheme (where a stream corresponding to a stream identifier is stored separately from data corresponding to the same stream identifier and a sub-stream identifier).

CLS 1002 may include demultiplexer cluster 1026 that includes any suitable number of nodes (e.g., demuxers 1032A-1032Z, collectively referred to as “demuxers 1032”). Any suitable combination of demuxers 1032 may include one or more smartNICs (e.g., smartNIC 165 of FIG. 1) which may execute an agent (e.g., BSA 160 of FIG. 6, a corresponding agent such as persistent storage agent 1018, or the like) that may be configured to manage storage of data within persistent storage (e.g., an example of persistent storage 1020). By way of example, each of the demuxers 1032 may include in-memory storage as well as disk storage (e.g., persistent storage 1020) that may be configured to store data based at least in part on a non-volatile memory express (NVMe) protocol. In some embodiments, the disk storage of demuxers 1032 may be any suitable flash memory or solid-state drives.

Each of the demuxers 1032 may be configured to execute one of data managers 1034A-1034Z (collectively referred to as “data managers 1034”). Each of the data managers 1034 may be an example of an embedded software library and/or database for key-value data (e.g., Berkeley Database, rocksDB, etc.). Each of the demuxers 1032 may manage one or more containers (not depicted in FIG. 10). A “container” refers to a data structure that is configured to store data corresponding to a StreamID which may include any suitable data corresponding to any suitable Sub-streamID that is associated with the same StreamID.

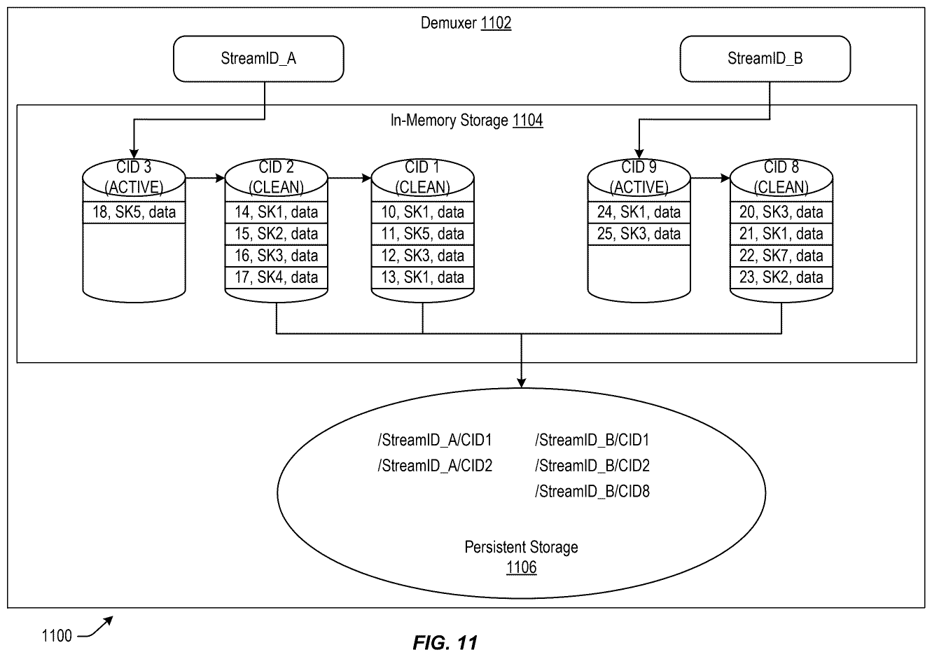

FIG. 11 is a block diagram depicting an example demuxer (e.g., demuxer 1102, an example of demuxers 1030 of FIG. 10), according to at least one embodiment. Demuxer 1102 may be configured to manage any suitable number of containers corresponding to any suitable number of streams. As depicted in FIG. 11, demuxer 1102 may register to receive events from DSP 1024 of FIG. 10 for streams corresponding to “StreamID_A” and “StreamID_B.”

Demuxer 1102 may be configured to manage any suitable number of containers corresponding to StreamID_A and/or StreamID_B in in-memory storage 1104 and/or persistent storage 1106 (e.g., an example of persistent storage 870 of FIG. 8, NVMe storage of demuxer 1102, a smartNIC). Each of the containers stored within in-memory storage 1104 and/or persistent storage 1106 may be associate with a container identifier (also referred to as a “CID,” for brevity). As depicted in FIG. 11, demuxer 1102 may currently be storing three containers corresponding to StreamID_A (e.g., containers corresponding to CID 1, CID, 2, and CID 3) and two containers corresponding to StreamID_B (e.g., containers corresponding to CID 8 and CID 9) within in-memory storage 1104. Demuxer 1102 of FIG. 11 may also be storing five containers (e.g., CID 1 and CID 2 corresponding to StreamID_A and CID 1, CID 2, and CID 8 corresponding to StreramID_B) within persistent storage 1106.

In some embodiments, each of the containers may be configured to store data corresponding to data for a specific StreamID, including any suitable data corresponding to one or more Sub-streamIDs that are associated with the same StreamID. Containers may not be shared across streams. That is, containers may, in some embodiments, store data corresponding to only one stream.

In some embodiments, a container may be associated with a state. The state may include a value that indicates that the container is “active” or “closed.” In some embodiments, an active container (e.g., a container that is associated with an “active” state) may be one that is currently configured to have payloads appended to it. In some embodiments, closed containers (e.g., containers that are associated with a “closed” state) may be immutable.

In some embodiments, each container may be associated with a storage location type such as “on_disk,” “on_disk+in-memory,” or “in-memory.” If a container is associated with a storage location type that indicates the container is “on_disk,” the container may be associated with a directory path and a filename to identify the location of the container within persistent storage 1106. If the container is associated with a storage location type of “in-memory,” the container may be associated with an in-memory object representing the container. If the container is associated with a storage location type of “on_disk+in_memory,” the container may be associated with both a directory path and filename that identifies the location of the container within persistent storage 1106 as well as being associated with an in-memory object that represents the container within in-memory storage 1104.

In some embodiments, each container may be associated with a persistence attribute that is associated with a corresponding value that indicates whether the container has been persisted in persistent storage 1106. As a non-limiting example, a container may be associated with a persistence attribute that has a value of “clean” when the container has been persisted within persistent storage 1106 and “dirty” when the container has not been persisted within persistent storage 1106. As seen in FIG. 11, CID 1 and CID 2 of StreamID_A may be associated with a persistence attribute value of “clean” since both containers have been persisted within persistent storage 1106. Similarly, CID 8 of StreamID_B may be associated with a persistence attribute value of “clean” since that container has been persisted in persistent storage 1106.

In some embodiments, in-memory storage 1104 may be any suitable size (e.g., 256 gigabytes (GB), 512 GB, etc.). Likewise, persistent storage 1106 may be any suitable size (e.g., 8 terabytes (TB), 4 TB, etc.). In some embodiments, each container may be associated with a maximum size (e.g., 32 megabytes (MB), 64 MB, 128 GB, etc.). A container may be assigned to a stream upon creation. All of the data corresponding to that stream may be demultiplexed into this container. When the data stored by the container reaches the container's maximum size (or at least approaches within a threshold), the container may be stored in persistent storage 1106 and deleted from in-memory storage 1104. In some embodiments, the data stored within a container of in-memory storage 1104 may periodically (e.g., according to a predefined protocol or scheme) may be persisted in persistent storage 1106. When the container includes data that has not yet been persisted, the container may be associated with a persistence attribute value of “dirty.” If all of the data stored within the container has been persisted in persistent storage 1106, the container may be associated with a persistence attribute value of “clean.” A subsequent data payload for a given stream may cause a new container to be created and associated with the corresponding StreamID. The new container may be used to append the new payload and any future payloads.

Each container may include any suitable number of entries that collectively do not exceed the container's maximum size. In some embodiments, each entry may be associated with a sequence number (“seqNum”), a sub-stream identifier (“Sub-streamID”), and a data payload. In some embodiments, each entry of a container may be in the form <seqNum, Sub-streamID, payload>. By way of example, the entry of CID 3 that is associated with StreamID_A may correspond to an event that is associated with sequence number 18, Sub-streamID “SK5,” and data corresponding to the payload of that event. In some embodiments, a container may be associated with any suitable metadata corresponding to a container ID (e.g., “CID 3”), a stream ID (e.g., “StreamID_A”), a starting sequence number (e.g., the first sequence number stored in the container), an offset (e.g., a sequence number associated with DSP 1024 of FIG. 10), a final sequence number (e.g., the last sequence number stored in the container), a final offset (e.g., a final sequence number associated with DSP 1024 within a partition), one or more timestamps (e.g., a timestamp indicating a time at which the container was created, a timestamp indicating a time at which the container was closed, etc.).

In some embodiments, a clean container (e.g., CID 1) may be persisted in in-memory storage 1104 according to a predefined protocol or scheme. Eventually, a clean container may be deleted from in-memory storage 1104 and only persisted in persistent storage 1106. CID 1 and CID 2 of StreamID_B are examples of containers that are associated with a persisted attribute value of “on_disk” and which have been persisted only in persistent storage 1106, having been previously deleted from in-memory storage 1104.

As can be seen in FIG. 11, containers corresponding to a single stream (e.g., CIDs 1-3, corresponding to StreamID_A) may store any suitable number of entries that correspond to any suitable number of sub-streams in the order in which the corresponding events were received. This may enable the demuxer 1102 to maintain the order of events with respect to both stream and sub-stream granularities. The approach depicted in FIG. 11 may be executed by a scalable data-streaming service (e.g., CLS 1002 of FIG. 10) that demultiplexes a data stream into a number of sub-streams, while maintaining a single copy of the data payloads obtained from the data stream. The single copy of the data payload is maintained at a stream level and data events corresponding to sub-streams of the stream are indexed within this single copy, enabling multiple granularities of streaming to occur without redundant data storage. Thus, the demultiplexer cluster may be configured to receive data from distributed streaming platform 1024 according to a second distribution scheme in which all data corresponding to a stream identifier, including data corresponding to any suitable sub-stream, is stored in a container that is associated with the stream identifier.

Returning to FIG. 10, each of the demuxers 1032 may execute a data manager (e.g., data manager 1034A-Z, collectively referred to as “data managers 1034”). In some embodiments, each of the data managers 1034 may be an example of an embedded software library and/or database for key-value data. Each of the data managers 1034 may be configured to maintain a container table that identifies a location of the container and/or an object that corresponding to the container within in-memory storage (e.g., within in-memory storage 1104 of FIG. 11). By way of example, demuxer 1032A may be an example of demuxer 1102 of FIG. 11 and may maintain a container table that indicates that container corresponding to container ID “CID 2” is associated with a persistent attribute value of “on_disk+in-memory,” a directory and filename corresponding to that container within persistent storage 1106, and a location of an object corresponding to CID 2 within in-memory storage 1104 of FIG. 11. Each of the demuxers 1032 may execute its own data manager to maintain storage locations/objects corresponding to each container it stores (e.g., in memory or within persistent storage).

In some embodiments, demuxers 1032 may individually register with DSP 1024 to receive any suitable number of streams corresponding to a StreamID. This may include any suitable events corresponding to one or more sub-streams that correspond to that StreamID. Once registered, a connection may be established between a demuxer and one or more brokers of 1026 (e.g., brokers that include partition(s) at which events corresponding to a StreamID are stored). In some embodiments, each of demuxers 1032 may be configured with predefined data indicating the StreamID(s) for which they are to register with DSP 1024. As a non-limiting example, demuxer 1032A (an example of the demuxer 1102 of FIG. 2) may be configured to register for two streams (e.g., streams with corresponding identifiers “StreamID_A” and “StreamID_B”). In some embodiments, at least some events corresponding StreamID_A may be stored within partition P1 of broker 1026A and at least some events corresponding to StreamID_B may be stored within partition P2 of broker 1026B. Once registered with DSP 1024, connections may be established between demuxer 1032A and brokers 1026A and 1026B as depicted at 1040. In some embodiments, a demuxer may register to obtain events corresponding to one or more sub-streams which may be distributed over any suitable number of partitions and/or brokers of DSP 1024.

In some embodiments, demuxers 1032 may include any suitable number of computing nodes (e.g., virtual instances configured as smart network interface cards). In some embodiments, demuxers 1032 may be scaled up or down to scale to a number of data clients. In some embodiments, the demuxers 1032 may be scaled up to handle 100,000, up to 1,000,000 or more data clients within the cloud-computing environment depicted in FIG. 10. This provides advantages of the distributed streaming platform 1024 which may be limited to a maximum number of brokers 1026 and/or partitions that fails to enable the distributed streaming platform 1024 to scale to 100,000 consumers (e.g., demuxers 1032), let alone 1,000,000. The ability for the demultiplexer cluster 1030 to scale to stream to 100,000 or more data clients is just one advantage realized through the use of the demultiplexer cluster 1030 in addition to the distributed streaming platform 1024 which enables scaling that otherwise would not be possible using the distributed streaming platform 1024 alone.

In some embodiments, DP client(s) 1016 may be configured to register with one or more of the demuxers 1032. As a non-limiting example, a DP client of DP client(s) 1016 may register with demuxer 1032A to obtain events corresponding to StreamID_A. As another example, the same client may instead register for one or more sub-streams (e.g., sub-streamIDs “SK1” and “SK5”) corresponding to StreamID_A. The term “registering” is intended to refer to sending a request to register or subscribe to a data channel corresponding to one or more data streams (e.g., by stream ID and, in some embodiments, by stream ID/sub-stream ID). Once registered, a record may be maintained by the demuxer corresponding to the stream (and sub-stream, in some embodiments) of the registered data clients. The data channel may be a connection established between a DP client and a demuxer. Registered data clients may also be referred to as “subscribers” that subscribe to the corresponding stream ID (and in some embodiments, the combination of stream ID and sub-stream ID. In some embodiments, once registered, connections may be established and maintained between demuxers 1032 and the DP client(s) that have registered for events. Each demuxer may maintain a record of the DP client(s) that have registered/subscribed and the stream identifiers and/or sub-stream identifiers for which the corresponding DP clients are registered. In some embodiments, when a demuxer receives an update corresponding to a registered stream and/or sub-stream, the demuxer may automatically transmit the update to the DP client(s) that are registered for that stream and/or sub-stream. In some embodiments, the DP client(s) 1016 may request access to a stream or a sub-stream (e.g., a stream inside a stream). Therefore, demuxers 1032 may be configured to maintain indices corresponding to a stream at one or more containers to ensure that sub-stream data can be extracted efficiently and delivered a DP client.

In some embodiments, DP client(s) 1016 may bootstrap off a pre-existing snapshot (e.g., a snapshot created by any suitable demuxer of demuxers 1032). In some embodiments, a snapshot of a data stream may be created on the fly (e.g., by request) and the new snapshot may be utilized to bootstrap a DP client. In some embodiments, a DP client may generate a list of <stream ID> and/or <stream ID/sub-stream ID> that it is interested in and includes the list in a bootstrap API request to one of demuxers 1032. In some embodiments, the demuxer (e.g., demuxer 1032A) may iterate over all the stream IDs provided by the client and provide the same to the data manager 1034A to determine the highest sequence number that has been recorded at StreamID granularity as of that point in time. If the DP client is interested in a subset of the data, (Stream ID+sub-stream ID), then highest sequence number may be determined for that combination as of that point in time.

Since the containers maintained by demuxer 1032A (and each of the demuxers 1032), demuxer 1032A may inherently provide snapshot isolation with versioning. A highest sequence number may be the target sequence number that bootstrap process needs to achieve for that specific Stream ID. Note that target sequence numbers can be different for different Stream IDs. Ordering of messages is at the granularity of Stream ID. Also, since demuxer 1032A is live, relevant streams could have additional control plane data events appended.

For all of the sub-components of Stream ID, payloads corresponding to less than or equal to highest sequence number is retrieved from the container(s) created by demuxer 1032A (and stored within in-memory storage 1104 and/or persistent memory 1106 of FIG. 11). For every sub-component, a list of n versions may be maintained by the data manager 1034A in the format of <seq number, CID>. The DP client may receive a list of all the Stream IDs and Stream IDs+sub-stream IDs with payloads and starting sequence number from the demuxer 1032A. After the bootstrap is done and the DP client reaches the sequence number at the start of bootstrap, further requests from the DP client will use the starting sequence number for every key that the client is interested in.

In some embodiments, snapshots can be created (e.g., by the demuxer 1032A) at a stream ID granularity or at a DP client granularity. For faster bootstrapping, snapshots may be generated for every client at a predefined frequency. The frequency of snapshots could be a control plane setting for demuxer, say once every three hours. A snapshot may record a list of stream IDs and/or stream IDs+sub-stream IDs that a DP client is interested in at the point in time. The latest versions of all the stream IDs, stream IDs+sub-stream IDs, sequence numbers, and corresponding payload(s) may be created as a single datafile and persisted onto NVMe and/or object storage. Bootstrapping off a snapshot may involve reading this file and streaming the information to the DP client since the snapshot may be customized for the DP client. After the bootstrapping is done, the DP client may roll forward to the current state by applying the recent changes received from the demuxer. New keys that has been subsequently added or keys that have been deleted may then be discovered by the DP client.

In some embodiments, the demuxers 1032 may have a preconfigured data retention period. The retention period (e.g., 7 days, 14 days, etc.) may be configured system wide. In some embodiments, the demuxer perform a dual role of demuxer as well as providing bootstrap support. If the number of version is set to 1 and the retention period is set to 7 days, at least one version of stream ID may be retained irrespective of the creation/mutation date on this stream ID. Extra versions or older versions are garbage collected.

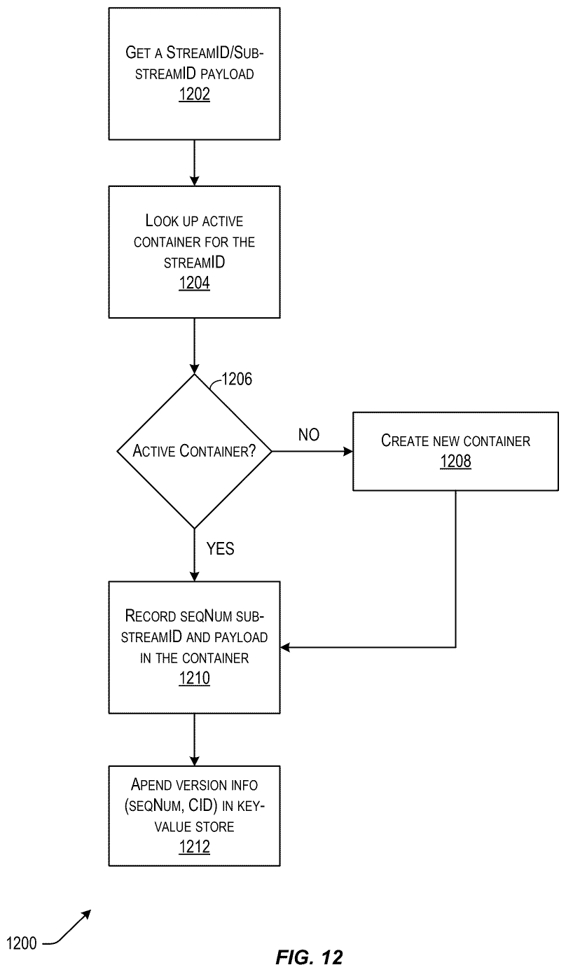

FIG. 12 is a block diagram depicting an example flow 1200 for writing data corresponding to a stream and/or a sub-stream, according to at least one embodiment. The operations of flow 1200 may be performed by any of demuxers 1032 of FIG. 10. In some embodiments, more or fewer operations than those depicted in flow 1200 may be executed. These operations may be executed in any suitable order.

At 1202, a stream ID/sub-stream ID payload may be obtained by a demuxer (e.g., demuxer 1032A) from a data payload source (e.g., broker 1026A of distributed streaming platform 1024 of FIG. 10). As a non-limiting example, the data payload (also referred to as “payload,” for brevity) may corresponding to Stream ID “A” and Sub-stream ID “XYZ” and sequence number 10.

At 1204, demuxer 1032A may look up the active container corresponding to the Stream ID. In some embodiments, performing this look up may include transmitting data to data manager 1034A of FIG. 10. As a non-limiting example demuxer 1032A may provide the Stream ID “A” to data manager 1034A. Data manager 1034A may be configured to maintain a container table that indicates the on-disk location(s) and/or in-memory object(s) corresponding to each stream to which demuxer 1032A is subscribed/registered. As a non-limiting example, CIDs 1-3 of FIG. 11 may be each associated with Stream ID “A.” CID 1 and CID 2 may be associated with a closed state, and CID 3 may be associated with an active state. In some embodiments, demuxer 1032A may be configured to request the location and/or identifier corresponding to the object that represents the active container (e.g., CID 3), if one exists, that is associated with a stream corresponding to a Stream ID provided by the demuxer 1032A. As described above, no more than one container may be active for a stream at any given time. Data manager 1034A may be configured to return the location and/or identifier associated with the container if one exists. In some embodiments, data manager 1034A may be configured to return a null value or another suitable value that indicates the container does not exist if an active container corresponding to is not found within the container table maintained by data manager 1034A.

At 1206, the demuxer 1032A may make a determination as to whether an active container exists. In some embodiments, this determination may be based at least in part on the value returned by the data manager 1034A in response to the request provided by the demuxer 1032A at 1204. If no active container was found by the data manager 1034A (e.g., a null value or other suitable value was returned indicating that no active container exists for the stream ID provided) the flow 1200 may proceed to 1208.

At 1208, demuxer 1032A may generate a new container. In some embodiments, this may include instantiating a new in-memory container object and associating the container (e.g., an attribute and/or metadata corresponding to the container) with a container identifier and stream identifier corresponding to the Stream ID “A.” Demuxer 1032A may be configured to generate any suitable container metadata corresponding to the newly generated contained (e.g., container ID, stream ID, first sequence number stored in the container, final/last sequence number stored in the container, a timestamp indicating a time at which the container was created, a timestamp indicating a time at which the container was initially active, a timestamp indicating a time at which the container transitioned to a closed state, or the like). In some embodiments, the demuxer 1032A may be configured to generate container identifiers based at least in part on ensuring that each container identifier is unique with respect to all containers currently associated with the same stream identifier (e.g., containers associated with Stream ID “A,” in this example). The container object may be instantiated and/or stored within in-memory storage 1104 of FIG. 11. The container metadata may be updated with the container ID, the stream ID, and a timestamp indicating a time at which the container was created. In some embodiments, demuxer 1032A may provide an address in memory (e.g., an address within in-memory storage 1104) to data manager 1034A. Data manager 1034A may be configured to store the address of the container object in memory (e.g., in-memory storage 1104) and/or any suitable container metadata within its container table. In some embodiments, if a container table does not previously exist, data manager 1034A may generate a new container table and add the newly generated container's address to the table. The container table may maintain and association between the address of the in-memory container object, the container identifier, and the stream identifier. Once the container is generated, the flow may proceed to 1210. In some embodiments, if an active container for the Stream ID “A” already existed, then the flow may jump from 1206 to 1210 directly without generating a new container as described at 1208.

At 1210, demuxer 1032A may add data to the active container. By way of example, the demuxer 1032A may add an entry including a sequence number, a sub-streamID, and the data payload to the active container. In some embodiments, this entry may be appended at the end of the container to ensure that order of the stream, as well as any entries corresponding to sub-streams of that stream, is maintained. In some embodiments, the demuxer 1032A may update container metadata corresponding to the container based at least in part on adding the data to the active container. As a non-limiting example, the final sequence number associated with the container may be updated to indicate the sequence number of the newly added entry. If no previous entries exist within the container, the starting sequence number of the container metadata may also be updated to include the newly added (and in this case, only) entry.

At 1212, the container metadata may be provided and persisted by the data manager 1034A. The data manager 1034A may be configured to store a list of key-value pairs that include a Stream ID or a Stream ID/Sub-stream ID combination as a key and a set of sequence numbers corresponding to one or more containers (as identified by container ID). As a non-limiting example, data manager 1034A may store <stream ID, sub-stream ID> as partition key and clustering key and a set data pairs such as <100, abcde>, <55, abcde>, <20, mnop>, etc. This indicates that the latest entry of stream ID “A,” sub-stream ID “XYZ” is present in a container corresponding to the container ID “abcde.” The same container may be identified as including older data for the stream/sub-stream corresponding to sequence number 55 based on the data pair <55, abcde>. Still older data for the stream/sub-stream corresponding to sequence number 20 may be identified as being stored within a container corresponding to a container ID of “mnop.”

By utilizing the approach provided above, a specific entry of the stream ID/sub-stream ID may be extracted, and quickly, based at least in part on providing the sequence number to the data manager 1034A. The data manager 1034A may be configured to identify the container ID associated with the sequence number and may return the address of an object representing the container within in-memory storage 1104 (e.g., RAM of the demuxer 1102), if one exists and if not, an address within persistent storage 1106 of FIG. 11 corresponding to the container. If the container is stored only in persistent storage 1106, the container may be loaded into in-memory storage 1104 based at least in part on receiving a request for an entry included within a container that was previously stored only within persistent storage. This approach also ensures that the latest containers (e.g., containers still stored in in-memory storage 1104) may be utilized to enable random-access performance. For example, a DP client may request from the demuxer 1032A any suitable entry corresponding to an in-memory container based at least in part on providing the sequence number corresponding to the entry desired. Additionally, by storing payloads separately from container metadata, storage limitations of databases can be avoided since only metadata is stored within the data managers 1034.

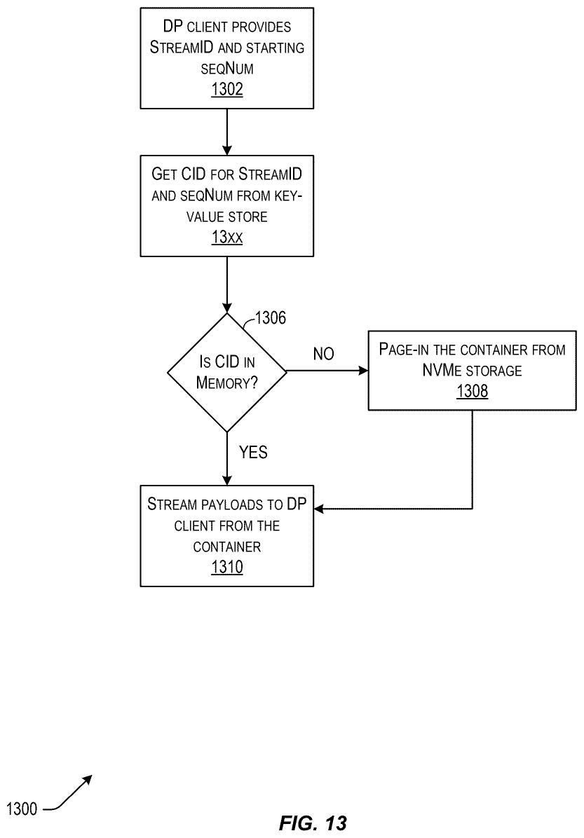

FIG. 13 is a block diagram depicting an example flow 1300 for reading data from an in-memory container, according to at least one embodiment. The operations of flow 1300 may be performed by any of demuxers 1032 of FIG. 10. In some embodiments, more or fewer operations than those depicted in flow 1300 may be executed. These operations may be executed in any suitable order. Flow 1300 may enable a DP client to access a specific container entry by sequence number.

At 1302, a DP client (e.g., one of DP client(s) 1016 of FIG. 10) may provide a stream ID (e.g., “A”) and starting sequence number (e.g., “55”) to a demuxer corresponding to the stream ID. In some embodiments, the DP client is not necessarily knowledgeable about which demuxer handles containers corresponding to a given stream ID. Rather, in some embodiments, DP client may be configured to identify a particular connection that is associated with a stream ID, without necessarily knowing which demuxer (e.g., demuxer 1032A) is acting as the other endpoint of the connection).

At 1304, demuxer 1032A may be configured to look up the container identifier for the container corresponding to stream ID “A” and a specific sequence number “55.” In some embodiments, this example may include sub-stream ID “XYZ.” Demuxer 1032A may provide the stream ID (and if included in the data provided at 1302, the sub-stream ID) to the data manager 1034A of FIG. 10. Data manager 1034A (e.g., a key-value store) may be configured to identify (e.g., from the container metadata stored in a container table maintained by the data manager 1034A) a set of value pairs that are associated with the stream ID (and, if provided, the sub-streamID). Once obtained, data manager 1034A may be configured to identify, from the set of value pairs associated with the stream ID (and potentially sub-stream ID) provided (e.g., <100, abcde>, <55, abcde>, <20, mnop> as provided in the example above) that the corresponding to container ID “abcde” includes the entry corresponding to the requested sequence number (e.g., 55).

At 1306, a determination may be made as to whether the container corresponding to the identified container ID is stored within in-memory storage 1102 of FIG. 11. This may include identifying that the container ID is associated with a persistent attribute value of a particular value (e.g., “in-memory,” or “on_disk+in_memory”, etc.). In some embodiments, if the container metadata corresponding to the container associated with container ID “abcde” indicates the container is not stored within in-memory storage 1104 of FIG. 11, the flow 1300 may proceed to 1308. If the container is already stored with in-memory storage 1104, the flow 1300 may proceed to 1310.

At 1308, if the container is not currently stored within in-memory storage 1104, the container may be paged in from persistent storage 1106 of FIG. 11. Paging in the container may include moving or copying the container from persistent storage 1106 to in-memory storage 1104. In some embodiments, paging in the container may include updating the container metadata to indicate that the container is associated with a persistent attribute of “in-memory” if the container is moved from persistent storage 1106 to in-memory storage 1104 or “on_disk+in_memory” if the container is copied from persistent storage 1106 to in-memory storage 1104.

At 1310, the requested payload(s) may be steamed to the DP client from the container.

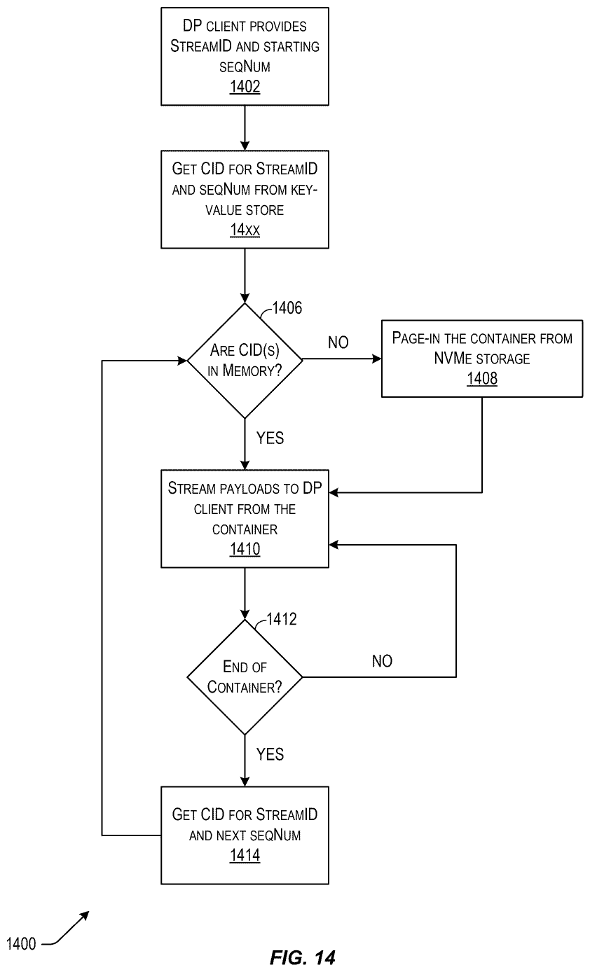

FIG. 14 is a block diagram depicting an example flow 1400 for reading data from one or more in-memory containers, according to at least one embodiment. The operations of flow 1400 may be performed by any of demuxers 1032 of FIG. 10. In some embodiments, more or fewer operations than those depicted in flow 1400 may be executed. These operations may be executed in any suitable order.

At 1402, a DP client (e.g., one of DP client(s) 1016 of FIG. 10) may provide a stream ID (e.g., “A”) and starting sequence number (e.g., “55”) to a demuxer corresponding to the stream ID. In some embodiments, the DP client is not necessarily knowledgeable about which demuxer handles containers corresponding to a given stream ID. Rather, in some embodiments, DP client may be configured to identify a particular connection that is associated with a stream ID, without necessarily knowing which demuxer (e.g., demuxer 1032A) is acting as the other endpoint of the connection).

At 1404, demuxer 1032A may be configured to look up the container identifier for the container corresponding to stream ID “A” and sequence number “20.” In some embodiments, this example may include sub-stream ID “XYZ.” Demuxer 1032A may provide the stream ID (and if included in the data provided at 1302, the sub-stream ID) to the data manager 1034A of FIG. 10. Data manager 1034A (e.g., a key-value store) may be configured to identify (e.g., from the container metadata stored in a container table maintained by the data manager 1034A) a set of value pairs that are associated with the stream ID (and, if provided, the sub-stream ID). Once obtained, data manager 1034A may be configured to identify, from the set of value pairs associated with the stream ID (and potentially sub-stream ID) provided (e.g., <100, abcde>, <55, abcde>, <20, mnop> as provided in the example above) that container ID “mnop” includes the entry corresponding to the starting sequence number (e.g., “20”). In some embodiments, it may also be determined that container ID “abcde” includes data entries corresponding to stream ID “A” and sub-stream ID “XYZ.” By way of example, the container corresponding to container ID “abcde” may be identified (from the set of value pairs) as including the entries “55” and “100” corresponding to stream ID “A” and sub-stream ID “XYZ.”

At 1406, a determination may be made as to whether the container(s) corresponding to the identified container ID is stored within in-memory storage 1102 of FIG. 11. This may include identifying that the container ID (e.g., container “mnop”) is associated with a persistent attribute value of a particular value (e.g., “in-memory,” or “on_disk+in_memory”, etc.). In some embodiments, if the container metadata associated with container ID “mnop” indicates that the corresponding container is not stored within in-memory storage 1104 of FIG. 11, the flow 1400 may proceed to 1408. If the container is already stored with in-memory storage 1104, the flow 1400 may proceed to 1410.

At 1408, if the container (e.g., the container corresponding to container ID “mnop”) is not currently stored within in-memory storage 1104, the container may be paged in from persistent storage 1106 of FIG. 11. Paging in the container may include moving or copying the container from persistent storage 1106 to in-memory storage 1104. In some embodiments, paging in the container may include updating the container metadata to indicate that the container is associated with a persistent attribute of “in-memory” if the container is moved from persistent storage 1106 to in-memory storage 1104 or “on_disk+in_memory” if the container is copied from persistent storage 1106 to in-memory storage 1104.

At 1410, any suitable number of payload(s) may be steamed to the DP client from the container in the order in which those payloads are stored (e.g., by sequence number). This may continue until the end of the container is reached.

At 1412, a determination may be made as to whether the end of the container has been reached. If not, the flow 1400 may proceed back to 1410 to stream additional payloads from the container until the end of the container is reached. Once the end of the container is reached, the flow 1400 may proceed to 1414.

At 1414, the container ID for another container that is associated with the stream ID/sub-stream ID may be identified from the set of value pairs (e.g., the container “abcde”) and the flow may proceed back to 1406, where a determination as to whether the container is currently stored within in-memory storage 1104 may be made. The operations of 1406-1414 may be repeated any suitable number of times to stream the payloads associated with stream ID “A” and sub-stream ID “XYZ” and corresponding to sequence number 55 and sequence number 100, respectively, to the requesting data client.

Although not depicted in flow 1400, it should be appreciated that, in some embodiments, to ensure that garbage collection can be done efficiently, periodic materialization of stream ID may be performed to create a bootstrap image for a stream ID. For example, on a weekly basis, or at any suitable time or according to any suitable predefined schedule, a bootstrap image of stream ID “A” may be created and the containers that previously stored the payloads corresponding to stream ID may be deleted.

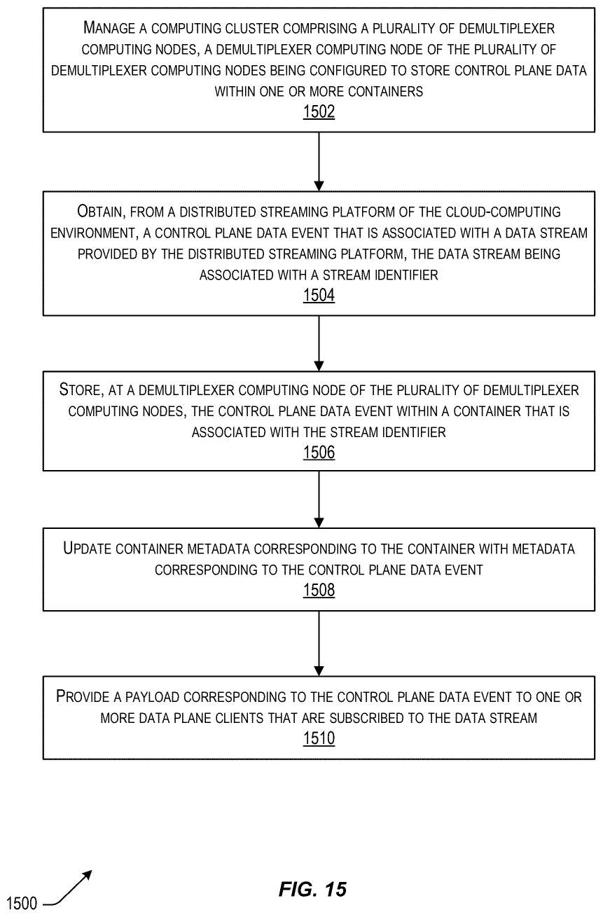

FIG. 15 is a block diagram depicting an example method 1500 for utilizing in-memory containers, according to at least one embodiment. The method 1500 may be performed by any suitable component of the cached log service 1002 of FIG. 10. Method 1500 may include more or fewer operations than the number shown in FIG. 15. In some embodiments, the operations of method 1500 may be performed in any suitable order.

At 1502, a cached log service of a cloud-computing service may manage a computing cluster comprising a plurality of demultiplexer computing nodes (e.g., demuxers 1032 of demultiplexer cluster 1030 of FIG. 10). In some embodiments, a demultiplexer computing node of the plurality of demultiplexer computing nodes may be configured to store control plane data within one or more containers (e.g., the containers of FIG. 3).

At 1504, the cached log service may obtain, from a distributed streaming platform (e.g., distributed streaming platform 1024 of FIG. 10, an example of which may include Apache Kafka®, a control plane data event that is associated with a data stream provided by the distributed streaming platform. In some embodiments, the data stream may be associated with a stream identifier.

At 1506, the cached log service may store the control plane data event within a container (e.g., container corresponding to container identifier “CID 3,” depicted in FIG. 11). In some embodiments, the container is associated with the stream identifier and stored at the demultiplexer computing node of the plurality of demultiplexer computing nodes.

At 1508, the cached log service may update container metadata corresponding to the container with metadata corresponding to the control plane data event. By way of example, the cached log service may update container metadata comprising any suitable combination of a container ID, a stream ID, a first sequence number stored in the container, a final/last sequence number stored in the container, a timestamp indicating a time at which the container was created, a timestamp indicating a time at which the container was initially active, a timestamp indicating a time at which the container transitioned to a closed state, or the like.

At 1510, the cached log service may provide (e.g., via demuxers 1032) a payload corresponding to the control plane data event to one or more data clients (one or more of DP client(s) 1016 of FIG. 10) that are subscribed to the data stream.

Although not depicted, the method 1500 may comprise adding a new demultiplexer computing node to the plurality of demultiplexer computing nodes based at least in part on identifying that the one or more data clients has increased in quantity. By way of example, if demuxers 1032 obtain or receive data indicating that the number of DP client(s) 1016 of FIG. 10 has breached a predefined threshold (e.g., a maximum number of DP clients for a current number of demuxers) the cached log service may be configured to scale the number of demuxers to service the increased number of DP clients.

In some embodiments, control plane data events are distributed to the distributed streaming platform (e.g., distributed streaming platform 1024) according to a first distribution scheme, and the distributed streaming platform distributes the control plane data events to the plurality of demultiplexer computing nodes according to a second distribution scheme that differs from the first distribution scheme. By way of example, the distributed streaming platform 1024 of FIG. 10 may be configured to receive data streams corresponding to stream ID and stream ID+sub-stream ID as separate data streams. However, the demuxers 1032 may be configured to maintain these data streams according to a second distribution scheme. By way of example, the demuxers may be configured to store data stream events corresponding to the same stream ID, irrespective of sub-stream ID. This may enable the order for both granularities of stream and sub-stream to be maintained.

In some embodiments, the plurality demultiplexer computing nodes may be scaled to service 100,000 to 1,000,000 data clients within the cloud-computing environment.

In some embodiments, the cached log service may be configured to allow data clients (e.g., DP client(s) 1016) to subscribe (e.g., register) to a data channel corresponding to a respective stream or a combination of the respective stream and a sub-stream that is associated with the respective steam.

The method 1500 may further comprise receiving, from a data client, a bootstrap request corresponding to the data stream, and providing, to the data client, a snapshot that was previously generated to include a sequential list of control plane data events corresponding to the data stream.

In some embodiments, the plurality of demultiplexer computing nodes (e.g., demuxers 1032 of FIG. 10) are individually configured as a smart network interface card (e.g., smartNIC 165 of FIG. 1) comprising a memory for which access is obtained via a non-volatile memory express protocol (e.g., persistent memory 1106 of FIG. 11).

In some embodiments, the demultiplexer computing node comprises a virtual instance corresponding to a smart network interface card and configured with a first predefined amount of random access memory (e.g., in-memory storage 1104 of FIG. 11) and a second predefined amount of non-volatile memory express storage (e.g., persistent storage 1106 of FIG. 11).

In some embodiments, the plurality of demultiplexer computing nodes initially store containers of data stream events in random access memory (e.g., in-memory storage 1104) and subsequently persist the data stream events in the non-volatile memory express storage (e.g., persistent storage 1106).

In some embodiments, the data stream is associated with the data stream and a sub-stream of the data stream.

In some embodiments, the control plane data event is further associated with a sub-stream and the one or more containers are individually configured to store control plane data events corresponding to a common stream identifier and one or more sub-stream identifiers that are associated with the common stream identifier.

In some embodiments, the method 1500 may comprise receiving, from a data client, a registration request indicating at least the stream identifier, and in response to the registration request, maintaining a record indicating that the data client is subscribed to the data stream corresponding to the stream identifier.

In some embodiments, the method 1500 may comprise 1) receiving, from a respective data client, a request for control plane data corresponding to a sequence number, 2) identifying, from the container metadata, a particular container that stores a corresponding control plane data event corresponding to the sequence number, 3) obtaining, from the particular container, the control plane data corresponding to the sequence number, and 4) providing, to the respective data client, the control plane data obtained from the particular container and corresponding to the sequence number.

In some embodiments, the one or more containers are associated with an active state or a closed state, and the one or more containers are restricted to enforce that only one container corresponding to the data stream is associated with the active state at any time.

In some embodiments, a single copy of the control plane data (e.g., a control plane data event) is stored within the one or more containers at any given time. One entry of a container may store a payload of a single control plane data event.

In some embodiments, the method 1500 may further comprise redistributing the control plane data event to one or more data plane clients according to the data stream and a sub-stream identified from the control plane data event.

In some embodiments, each of the plurality of demultiplexer computing nodes executes a respective data manager (e.g., data manager(s) 1034 of FIG. 10). In some embodiments, the data manager is a key-value store manager (e.g., Berkely database, rocksDB, etc.). In some embodiments, the data manager maintains a container table comprising the container metadata.

### Example Infrastructure as a Service Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 16 is a block diagram 1600 illustrating an example pattern of an IaaS architecture, according to at least one embodiment. Service operators 1602 can be communicatively coupled to a secure host tenancy 1604 that can include a virtual cloud network (VCN) 1606 and a secure host subnet 1608. In some examples, the service operators 1602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1606 and/or the Internet.

The VCN 1606 can include a local peering gateway (LPG) 1610 that can be communicatively coupled to a secure shell (SSH) VCN 1612 via an LPG 1610 contained in the SSH VCN 1612. The SSH VCN 1612 can include an SSH subnet 1614, and the SSH VCN 1612 can be communicatively coupled to a control plane VCN 1616 via the LPG 1610 contained in the control plane VCN 1616. Also, the SSH VCN 1612 can be communicatively coupled to a data plane VCN 1618 via an LPG 1610. The control plane VCN 1616 and the data plane VCN 1618 can be contained in a service tenancy 1619 that can be owned and/or operated by the IaaS provider.

The control plane VCN 1616 can include a control plane demilitarized zone (DMZ) tier 1620 that acts as a perimeter network (e.g., portions of a corporate network between the corporate intranet and external networks). The DMZ-based servers may have restricted responsibilities and help keep breaches contained. Additionally, the DMZ tier 1620 can include one or more load balancer (LB) subnet(s) 1622, a control plane app tier 1624 that can include app subnet(s) 1626, a control plane data tier 1628 that can include database (DB) subnet(s) 1630 (e.g., frontend DB subnet(s) and/or backend DB subnet(s)). The LB subnet(s) 1622 contained in the control plane DMZ tier 1620 can be communicatively coupled to the app subnet(s) 1626 contained in the control plane app tier 1624 and an Internet gateway 1634 that can be contained in the control plane VCN 1616, and the app subnet(s) 1626 can be communicatively coupled to the DB subnet(s) 1630 contained in the control plane data tier 1628 and a service gateway 1636 and a network address translation (NAT) gateway 1638. The control plane VCN 1616 can include the service gateway 1636 and the NAT gateway 1638.

The control plane VCN 1616 can include a data plane mirror app tier 1640 that can include app subnet(s) 1626. The app subnet(s) 1626 contained in the data plane mirror app tier 1640 can include a virtual network interface controller (VNIC) 1642 that can execute a compute instance 1644. The compute instance 1644 can communicatively couple the app subnet(s) 1626 of the data plane mirror app tier 1640 to app subnet(s) 1626 that can be contained in a data plane app tier 1646.

The data plane VCN 1618 can include the data plane app tier 1646, a data plane DMZ tier 1648, and a data plane data tier 1650. The data plane DMZ tier 1648 can include LB subnet(s) 1622 that can be communicatively coupled to the app subnet(s) 1626 of the data plane app tier 1646 and the Internet gateway 1634 of the data plane VCN 1618. The app subnet(s) 1626 can be communicatively coupled to the service gateway 1636 of the data plane VCN 1618 and the NAT gateway 1638 of the data plane VCN 1618. The data plane data tier 1650 can also include the DB subnet(s) 1630 that can be communicatively coupled to the app subnet(s) 1626 of the data plane app tier 1646.

The Internet gateway 1634 of the control plane VCN 1616 and of the data plane VCN 1618 can be communicatively coupled to a metadata management service 1652 that can be communicatively coupled to public Internet 1654. Public Internet 1654 can be communicatively coupled to the NAT gateway 1638 of the control plane VCN 1616 and of the data plane VCN 1618. The service gateway 1636 of the control plane VCN 1616 and of the data plane VCN 1618 can be communicatively coupled to cloud services 1656.

In some examples, the service gateway 1636 of the control plane VCN 1616 or of the data plane VCN 1618 can make application programming interface (API) calls to cloud services 1656 without going through public Internet 1654. The API calls to cloud services 1656 from the service gateway 1636 can be one-way: the service gateway 1636 can make API calls to cloud services 1656, and cloud services 1656 can send requested data to the service gateway 1636. But, cloud services 1656 may not initiate API calls to the service gateway 1636.

In some examples, the secure host tenancy 1604 can be directly connected to the service tenancy 1619, which may be otherwise isolated. The secure host subnet 1608 can communicate with the SSH subnet 1614 through an LPG 1610 that may enable two-way communication over an otherwise isolated system. Connecting the secure host subnet 1608 to the SSH subnet 1614 may give the secure host subnet 1608 access to other entities within the service tenancy 1619.

The control plane VCN 1616 may allow users of the service tenancy 1619 to set up or otherwise provision desired resources. Desired resources provisioned in the control plane VCN 1616 may be deployed or otherwise used in the data plane VCN 1618. In some examples, the control plane VCN 1616 can be isolated from the data plane VCN 1618, and the data plane mirror app tier 1640 of the control plane VCN 1616 can communicate with the data plane app tier 1646 of the data plane VCN 1618 via VNICs 1642 that can be contained in the data plane mirror app tier 1640 and the data plane app tier 1646.

In some examples, users of the system, or customers, can make requests, for example create, read, update, or delete (CRUD) operations, through public Internet 1654 that can communicate the requests to the metadata management service 1652. The metadata management service 1652 can communicate the request to the control plane VCN 1616 through the Internet gateway 1634. The request can be received by the LB subnet(s) 1622 contained in the control plane DMZ tier 1620. The LB subnet(s) 1622 may determine that the request is valid, and in response to this determination, the LB subnet(s) 1622 can transmit the request to app subnet(s) 1626 contained in the control plane app tier 1624. If the request is validated and requires a call to public Internet 1654, the call to public Internet 1654 may be transmitted to the NAT gateway 1638 that can make the call to public Internet 1654. Metadata that may be desired to be stored by the request can be stored in the DB subnet(s) 1630.

In some examples, the data plane mirror app tier 1640 can facilitate direct communication between the control plane VCN 1616 and the data plane VCN 1618. For example, changes, updates, or other suitable modifications to configuration may be desired to be applied to the resources contained in the data plane VCN 1618. Via a VNIC 1642, the control plane VCN 1616 can directly communicate with, and can thereby execute the changes, updates, or other suitable modifications to configuration to, resources contained in the data plane VCN 1618.

In some embodiments, the control plane VCN 1616 and the data plane VCN 1618 can be contained in the service tenancy 1619. In this case, the user, or the customer, of the system may not own or operate either the control plane VCN 1616 or the data plane VCN 1618. Instead, the IaaS provider may own or operate the control plane VCN 1616 and the data plane VCN 1618, both of which may be contained in the service tenancy 1619. This embodiment can enable isolation of networks that may prevent users or customers from interacting with other users', or other customers', resources. Also, this embodiment may allow users or customers of the system to store databases privately without needing to rely on public Internet 1654, which may not have a desired level of threat prevention, for storage.

In other embodiments, the LB subnet(s) 1622 contained in the control plane VCN 1616 can be configured to receive a signal from the service gateway 1636. In this embodiment, the control plane VCN 1616 and the data plane VCN 1618 may be configured to be called by a customer of the IaaS provider without calling public Internet 1654. Customers of the IaaS provider may desire this embodiment since database(s) that the customers use may be controlled by the IaaS provider and may be stored on the service tenancy 1619, which may be isolated from public Internet 1654.

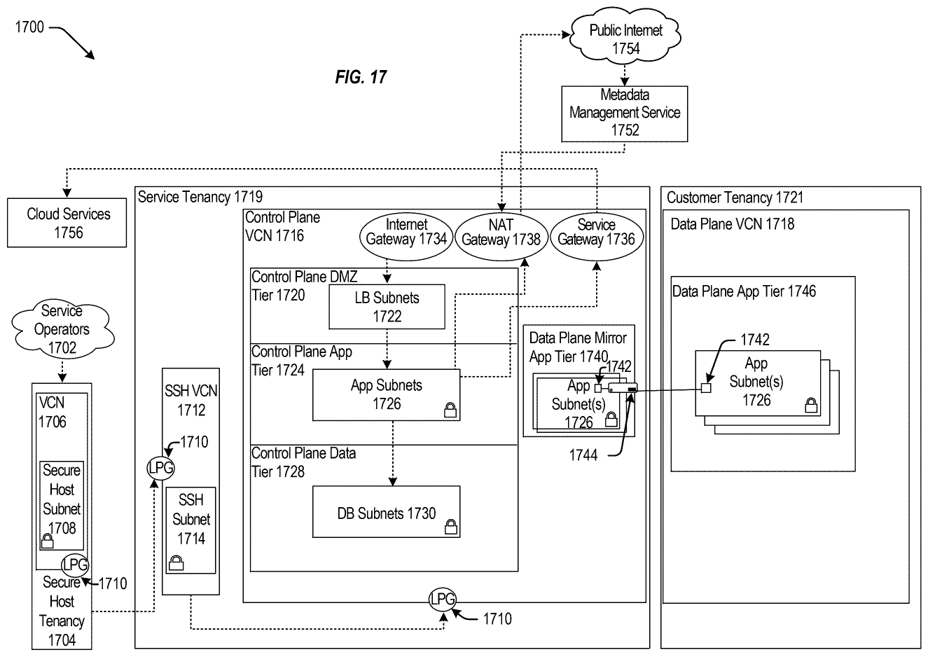

FIG. 17 is a block diagram 1700 illustrating another example pattern of an IaaS architecture, according to at least one embodiment. Service operators 1702 (e.g., service operators 1602 of FIG. 16) can be communicatively coupled to a secure host tenancy 1704 (e.g., the secure host tenancy 1604 of FIG. 16) that can include a virtual cloud network (VCN) 1706 (e.g., the VCN 1606 of FIG. 16) and a secure host subnet 1708 (e.g., the secure host subnet 1608 of FIG. 16). The VCN 1706 can include a local peering gateway (LPG) 1710 (e.g., the LPG 1610 of FIG. 16) that can be communicatively coupled to a secure shell (SSH) VCN 1712 (e.g., the SSH VCN 1612 of FIG. 16) via an LPG 1610 contained in the SSH VCN 1712. The SSH VCN 1712 can include an SSH subnet 1714 (e.g., the SSH subnet 1614 of FIG. 16), and the SSH VCN 1712 can be communicatively coupled to a control plane VCN 1716 (e.g., the control plane VCN 1616 of FIG. 16) via an LPG 1710 contained in the control plane VCN 1716. The control plane VCN 1716 can be contained in a service tenancy 1719 (e.g., the service tenancy 1619 of FIG. 16), and the data plane VCN 1718 (e.g., the data plane VCN 1618 of FIG. 16) can be contained in a customer tenancy 1721 that may be owned or operated by users, or customers, of the system.

The control plane VCN 1716 can include a control plane DMZ tier 1720 (e.g., the control plane DMZ tier 1620 of FIG. 16) that can include LB subnet(s) 1722 (e.g., LB subnet(s) 1622 of FIG. 16), a control plane app tier 1724 (e.g., the control plane app tier 1624 of FIG. 16) that can include app subnet(s) 1726 (e.g., app subnet(s) 1626 of FIG. 16), a control plane data tier 1728 (e.g., the control plane data tier 1628 of FIG. 16) that can include database (DB) subnet(s) 1730 (e.g., similar to DB subnet(s) 1630 of FIG. 16). The LB subnet(s) 1722 contained in the control plane DMZ tier 1720 can be communicatively coupled to the app subnet(s) 1726 contained in the control plane app tier 1724 and an Internet gateway 1734 (e.g., the Internet gateway 1634 of FIG. 16) that can be contained in the control plane VCN 1716, and the app subnet(s) 1726 can be communicatively coupled to the DB subnet(s) 1730 contained in the control plane data tier 1728 and a service gateway 1736 (e.g., the service gateway 1636 of FIG. 16) and a network address translation (NAT) gateway 1738 (e.g., the NAT gateway 1638 of FIG. 16). The control plane VCN 1716 can include the service gateway 1736 and the NAT gateway 1738.

The control plane VCN 1716 can include a data plane mirror app tier 1740 (e.g., the data plane mirror app tier 1640 of FIG. 16) that can include app subnet(s) 1726. The app subnet(s) 1726 contained in the data plane mirror app tier 1740 can include a virtual network interface controller (VNIC) 1742 (e.g., the VNIC of 1642) that can execute a compute instance 1744 (e.g., similar to the compute instance 1644 of FIG. 16). The compute instance 1744 can facilitate communication between the app subnet(s) 1726 of the data plane mirror app tier 1740 and the app subnet(s) 1726 that can be contained in a data plane app tier 1746 (e.g., the data plane app tier 1646 of FIG. 16) via the VNIC 1742 contained in the data plane mirror app tier 1740 and the VNIC 1742 contained in the data plane app tier 1746.

The Internet gateway 1734 contained in the control plane VCN 1716 can be communicatively coupled to a metadata management service 1752 (e.g., the metadata management service 1652 of FIG. 16) that can be communicatively coupled to public Internet 1754 (e.g., public Internet 1654 of FIG. 16). Public Internet 1754 can be communicatively coupled to the NAT gateway 1738 contained in the control plane VCN 1716. The service gateway 1736 contained in the control plane VCN 1716 can be communicatively coupled to cloud services 1756 (e.g., cloud services 1656 of FIG. 16).

In some examples, the data plane VCN 1718 can be contained in the customer tenancy 1721. In this case, the IaaS provider may provide the control plane VCN 1716 for each customer, and the IaaS provider may, for each customer, set up a unique compute instance 1744 that is contained in the service tenancy 1719. Each compute instance 1744 may allow communication between the control plane VCN 1716, contained in the service tenancy 1719, and the data plane VCN 1718 that is contained in the customer tenancy 1721. The compute instance 1744 may allow resources, which are provisioned in the control plane VCN 1716 that is contained in the service tenancy 1719, to be deployed or otherwise used in the data plane VCN 1718 that is contained in the customer tenancy 1721.

In other examples, the customer of the IaaS provider may have databases that live in the customer tenancy 1721. In this example, the control plane VCN 1716 can include the data plane mirror app tier 1740 that can include app subnet(s) 1726. The data plane mirror app tier 1740 can reside in the data plane VCN 1718, but the data plane mirror app tier 1740 may not live in the data plane VCN 1718. That is, the data plane mirror app tier 1740 may have access to the customer tenancy 1721, but the data plane mirror app tier 1740 may not exist in the data plane VCN 1718 or be owned or operated by the customer of the IaaS provider. The data plane mirror app tier 1740 may be configured to make calls to the data plane VCN 1718 but may not be configured to make calls to any entity contained in the control plane VCN 1716. The customer may desire to deploy or otherwise use resources in the data plane VCN 1718 that are provisioned in the control plane VCN 1716, and the data plane mirror app tier 1740 can facilitate the desired deployment, or other usage of resources, of the customer.

In some embodiments, the customer of the IaaS provider can apply filters to the data plane VCN 1718. In this embodiment, the customer can determine what the data plane VCN 1718 can access, and the customer may restrict access to public Internet 1754 from the data plane VCN 1718. The IaaS provider may not be able to apply filters or otherwise control access of the data plane VCN 1718 to any outside networks or databases. Applying filters and controls by the customer onto the data plane VCN 1718, contained in the customer tenancy 1721, can help isolate the data plane VCN 1718 from other customers and from public Internet 1754.

In some embodiments, cloud services 1756 can be called by the service gateway 1736 to access services that may not exist on public Internet 1754, on the control plane VCN 1716, or on the data plane VCN 1718. The connection between cloud services 1756 and the control plane VCN 1716 or the data plane VCN 1718 may not be live or continuous. Cloud services 1756 may exist on a different network owned or operated by the IaaS provider. Cloud services 1756 may be configured to receive calls from the service gateway 1736 and may be configured to not receive calls from public Internet 1754. Some cloud services 1756 may be isolated from other cloud services 1756, and the control plane VCN 1716 may be isolated from cloud services 1756 that may not be in the same region as the control plane VCN 1716. For example, the control plane VCN 1716 may be located in “Region 1,” and cloud service “Deployment 16,” may be located in Region 1 and in “Region 2.” If a call to Deployment 16 is made by the service gateway 1736 contained in the control plane VCN 1716 located in Region 1, the call may be transmitted to Deployment 16 in Region 1. In this example, the control plane VCN 1716, or Deployment 16 in Region 1, may not be communicatively coupled to, or otherwise in communication with, Deployment 16 in Region 2.

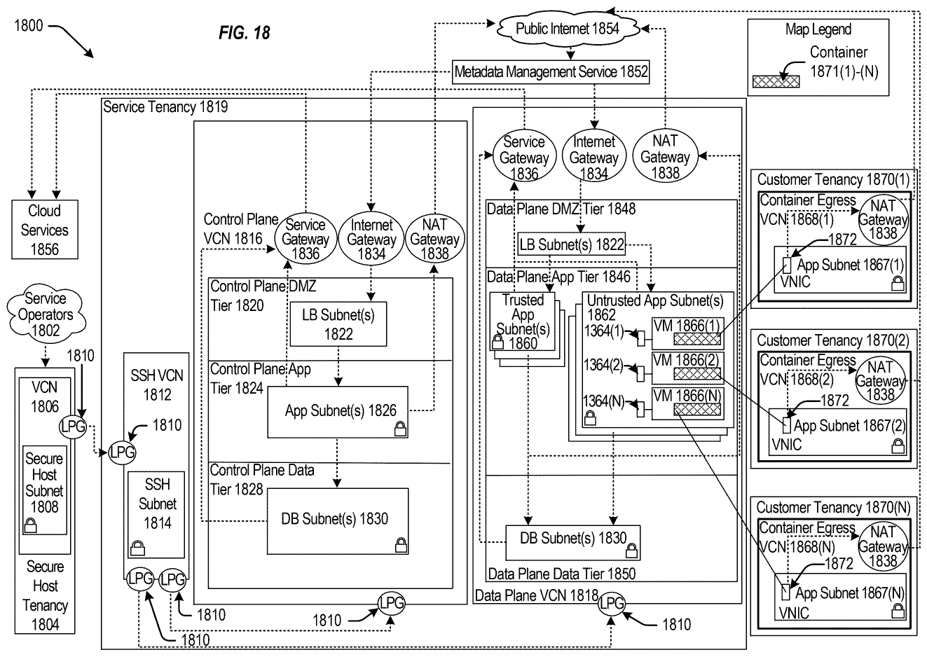

FIG. 18 is a block diagram 1800 illustrating another example pattern of an IaaS architecture, according to at least one embodiment. Service operators 1802 (e.g., service operators 1602 of FIG. 16) can be communicatively coupled to a secure host tenancy 1804 (e.g., the secure host tenancy 1604 of FIG. 16) that can include a virtual cloud network (VCN) 1806 (e.g., the VCN 1606 of FIG. 16) and a secure host subnet 1808 (e.g., the secure host subnet 1608 of FIG. 16). The VCN 1806 can include an LPG 1810 (e.g., the LPG 1610 of FIG. 16) that can be communicatively coupled to an SSH VCN 1812 (e.g., the SSH VCN 1612 of FIG. 16) via an LPG 1810 contained in the SSH VCN 1812. The SSH VCN 1812 can include an SSH subnet 1814 (e.g., the SSH subnet 1614 of FIG. 16), and the SSH VCN 1812 can be communicatively coupled to a control plane VCN 1816 (e.g., the control plane VCN 1616 of FIG. 16) via an LPG 1810 contained in the control plane VCN 1816 and to a data plane VCN 1818 (e.g., the data plane 1618 of FIG. 16) via an LPG 1810 contained in the data plane VCN 1818. The control plane VCN 1816 and the data plane VCN 1818 can be contained in a service tenancy 1819 (e.g., the service tenancy 1619 of FIG. 16).

The control plane VCN 1816 can include a control plane DMZ tier 1820 (e.g., the control plane DMZ tier 1620 of FIG. 16) that can include load balancer (LB) subnet(s) 1822 (e.g., LB subnet(s) 1622 of FIG. 16), a control plane app tier 1824 (e.g., the control plane app tier 1624 of FIG. 16) that can include app subnet(s) 1826 (e.g., similar to app subnet(s) 1626 of FIG. 16), a control plane data tier 1828 (e.g., the control plane data tier 1628 of FIG. 16) that can include DB subnet(s) 1830. The LB subnet(s) 1822 contained in the control plane DMZ tier 1820 can be communicatively coupled to the app subnet(s) 1826 contained in the control plane app tier 1824 and to an Internet gateway 1834 (e.g., the Internet gateway 1634 of FIG. 16) that can be contained in the control plane VCN 1816, and the app subnet(s) 1826 can be communicatively coupled to the DB subnet(s) 1830 contained in the control plane data tier 1828 and to a service gateway 1836 (e.g., the service gateway of FIG. 16) and a network address translation (NAT) gateway 1838 (e.g., the NAT gateway 1638 of FIG. 16). The control plane VCN 1816 can include the service gateway 1836 and the NAT gateway 1838.

The data plane VCN 1818 can include a data plane app tier 1846 (e.g., the data plane app tier 1646 of FIG. 16), a data plane DMZ tier 1848 (e.g., the data plane DMZ tier 1648 of FIG. 16), and a data plane data tier 1850 (e.g., the data plane data tier 1650 of FIG. 16). The data plane DMZ tier 1848 can include LB subnet(s) 1822 that can be communicatively coupled to trusted app subnet(s) 1860 and untrusted app subnet(s) 1862 of the data plane app tier 1846 and the Internet gateway 1834 contained in the data plane VCN 1818. The trusted app subnet(s) 1860 can be communicatively coupled to the service gateway 1836 contained in the data plane VCN 1818, the NAT gateway 1838 contained in the data plane VCN 1818, and DB subnet(s) 1830 contained in the data plane data tier 1850. The untrusted app subnet(s) 1862 can be communicatively coupled to the service gateway 1836 contained in the data plane VCN 1818 and DB subnet(s) 1830 contained in the data plane data tier 1850. The data plane data tier 1850 can include DB subnet(s) 1830 that can be communicatively coupled to the service gateway 1836 contained in the data plane VCN 1818.

The untrusted app subnet(s) 1862 can include one or more primary VNICs 1864(1)-(N) that can be communicatively coupled to tenant virtual machines (VMs) 1866(1)-(N). Each tenant VM 1866(1)-(N) can be communicatively coupled to a respective app subnet 1867(1)-(N) that can be contained in respective container egress VCNs 1868(1)-(N) that can be contained in respective customer tenancies 1870(1)-(N). Respective secondary VNICs 1872(1)-(N) can facilitate communication between the untrusted app subnet(s) 1862 contained in the data plane VCN 1818 and the app subnet contained in the container egress VCNs 1868(1)-(N). Each container egress VCNs 1868(1)-(N) can include a NAT gateway 1838 that can be communicatively coupled to public Internet 1854 (e.g., public Internet 1654 of FIG. 16).

The Internet gateway 1834 contained in the control plane VCN 1816 and contained in the data plane VCN 1818 can be communicatively coupled to a metadata management service 1852 (e.g., the metadata management system 1652 of FIG. 16) that can be communicatively coupled to public Internet 1854. Public Internet 1854 can be communicatively coupled to the NAT gateway 1838 contained in the control plane VCN 1816 and contained in the data plane VCN 1818. The service gateway 1836 contained in the control plane VCN 1816 and contained in the data plane VCN 1818 can be communicatively coupled to cloud services 1856.

In some embodiments, the data plane VCN 1818 can be integrated with customer tenancies 1870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1846. Code to run the function may be executed in the VMs 1866(1)-(N), and the code may not be configured to run anywhere else on the data plane VCN 1818. Each VM 1866(1)-(N) may be connected to one customer tenancy 1870. Respective containers 1871(1)-(N) contained in the VMs 1866(1)-(N) may be configured to run the code. In this case, there can be a dual isolation (e.g., the containers 1871(1)-(N) running code, where the containers 1871(1)-(N) may be contained in at least the VM 1866(1)-(N) that are contained in the untrusted app subnet(s) 1862), which may help prevent incorrect or otherwise undesirable code from damaging the network of the IaaS provider or from damaging a network of a different customer. The containers 1871(1)-(N) may be communicatively coupled to the customer tenancy 1870 and may be configured to transmit or receive data from the customer tenancy 1870. The containers 1871(1)-(N) may not be configured to transmit or receive data from any other entity in the data plane VCN 1818. Upon completion of running the code, the IaaS provider may kill or otherwise dispose of the containers 1871(1)-(N).

In some embodiments, the trusted app subnet(s) 1860 may run code that may be owned or operated by the IaaS provider. In this embodiment, the trusted app subnet(s) 1860 may be communicatively coupled to the DB subnet(s) 1830 and be configured to execute CRUD operations in the DB subnet(s) 1830. The untrusted app subnet(s) 1862 may be communicatively coupled to the DB subnet(s) 1830, but in this embodiment, the untrusted app subnet(s) may be configured to execute read operations in the DB subnet(s) 1830. The containers 1871(1)-(N) that can be contained in the VM 1866(1)-(N) of each customer and that may run code from the customer may not be communicatively coupled with the DB subnet(s) 1830.

In other embodiments, the control plane VCN 1816 and the data plane VCN 1818 may not be directly communicatively coupled. In this embodiment, there may be no direct communication between the control plane VCN 1816 and the data plane VCN 1818. However, communication can occur indirectly through at least one method. An LPG 1810 may be established by the IaaS provider that can facilitate communication between the control plane VCN 1816 and the data plane VCN 1818. In another example, the control plane VCN 1816 or the data plane VCN 1818 can make a call to cloud services 1856 via the service gateway 1836. For example, a call to cloud services 1856 from the control plane VCN 1816 can include a request for a service that can communicate with the data plane VCN 1818.

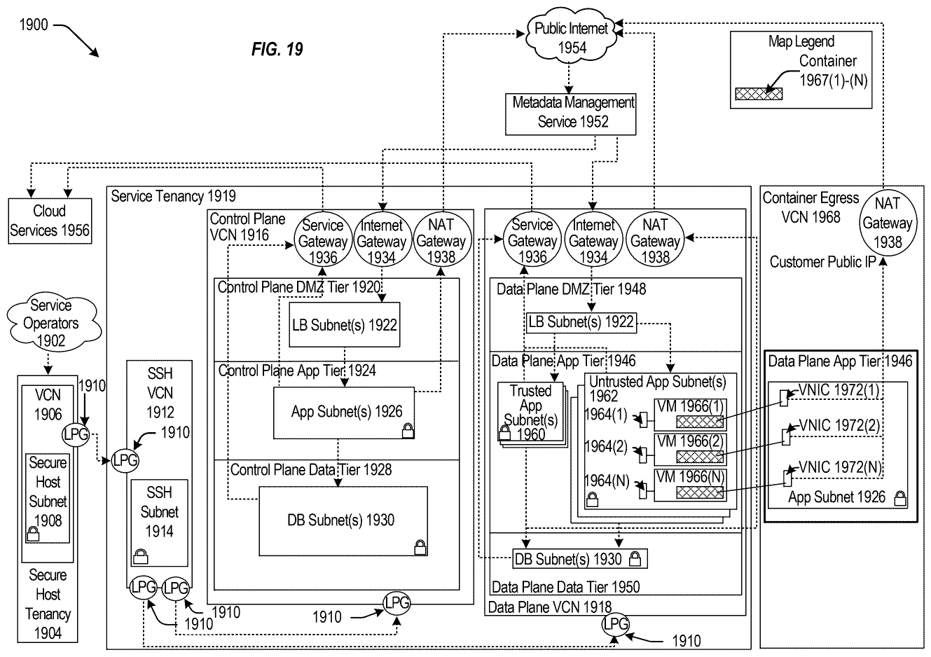

FIG. 19 is a block diagram 1900 illustrating another example pattern of an IaaS architecture, according to at least one embodiment. Service operators 1902 (e.g., service operators 1602 of FIG. 16) can be communicatively coupled to a secure host tenancy 1904 (e.g., the secure host tenancy 1604 of FIG. 16) that can include a virtual cloud network (VCN) 1906 (e.g., the VCN 1606 of FIG. 16) and a secure host subnet 1908 (e.g., the secure host subnet 1608 of FIG. 16). The VCN 1906 can include an LPG 1910 (e.g., the LPG 1610 of FIG. 16) that can be communicatively coupled to an SSH VCN 1912 (e.g., the SSH VCN 1612 of FIG. 16) via an LPG 1910 contained in the SSH VCN 1912. The SSH VCN 1912 can include an SSH subnet 1914 (e.g., the SSH subnet 1614 of FIG. 16), and the SSH VCN 1912 can be communicatively coupled to a control plane VCN 1916 (e.g., the control plane VCN 1616 of FIG. 16) via an LPG 1910 contained in the control plane VCN 1916 and to a data plane VCN 1918 (e.g., the data plane 1618 of FIG. 16) via an LPG 1910 contained in the data plane VCN 1918. The control plane VCN 1916 and the data plane VCN 1918 can be contained in a service tenancy 1919 (e.g., the service tenancy 1619 of FIG. 16).

The control plane VCN 1916 can include a control plane DMZ tier 1920 (e.g., the control plane DMZ tier 1620 of FIG. 16) that can include LB subnet(s) 1922 (e.g., LB subnet(s) 1622 of FIG. 16), a control plane app tier 1924 (e.g., the control plane app tier 1624 of FIG. 16) that can include app subnet(s) 1926 (e.g., app subnet(s) 1626 of FIG. 16), a control plane data tier 1928 (e.g., the control plane data tier 1628 of FIG. 16) that can include DB subnet(s) 1930 (e.g., DB subnet(s) 1830 of FIG. 18). The LB subnet(s) 1922 contained in the control plane DMZ tier 1920 can be communicatively coupled to the app subnet(s) 1926 contained in the control plane app tier 1924 and to an Internet gateway 1934 (e.g., the Internet gateway 1634 of FIG. 16) that can be contained in the control plane VCN 1916, and the app subnet(s) 1926 can be communicatively coupled to the DB subnet(s) 1930 contained in the control plane data tier 1928 and to a service gateway 1936 (e.g., the service gateway of FIG. 16) and a network address translation (NAT) gateway 1938 (e.g., the NAT gateway 1638 of FIG. 16). The control plane VCN 1916 can include the service gateway 1936 and the NAT gateway 1938.

The data plane VCN 1918 can include a data plane app tier 1946 (e.g., the data plane app tier 1646 of FIG. 16), a data plane DMZ tier 1948 (e.g., the data plane DMZ tier 1648 of FIG. 16), and a data plane data tier 1950 (e.g., the data plane data tier 1650 of FIG. 16). The data plane DMZ tier 1948 can include LB subnet(s) 1922 that can be communicatively coupled to trusted app subnet(s) 1960 (e.g., trusted app subnet(s) 1860 of FIG. 18) and untrusted app subnet(s) 1962 (e.g., untrusted app subnet(s) 1862 of FIG. 18) of the data plane app tier 1946 and the Internet gateway 1934 contained in the data plane VCN 1918. The trusted app subnet(s) 1960 can be communicatively coupled to the service gateway 1936 contained in the data plane VCN 1918, the NAT gateway 1938 contained in the data plane VCN 1918, and DB subnet(s) 1930 contained in the data plane data tier 1950. The untrusted app subnet(s) 1962 can be communicatively coupled to the service gateway 1936 contained in the data plane VCN 1918 and DB subnet(s) 1930 contained in the data plane data tier 1950. The data plane data tier 1950 can include DB subnet(s) 1930 that can be communicatively coupled to the service gateway 1936 contained in the data plane VCN 1918.

The untrusted app subnet(s) 1962 can include primary VNICs 1964(1)-(N) that can be communicatively coupled to tenant virtual machines (VMs) 1966(1)-(N) residing within the untrusted app subnet(s) 1962. Each tenant VM 1966(1)-(N) can run code in a respective container 1967(1)-(N), and be communicatively coupled to an app subnet 1926 that can be contained in a data plane app tier 1946 that can be contained in a container egress VCN 1968. Respective secondary VNICs 1972(1)-(N) can facilitate communication between the untrusted app subnet(s) 1962 contained in the data plane VCN 1918 and the app subnet contained in the container egress VCN 1968. The container egress VCN can include a NAT gateway 1938 that can be communicatively coupled to public Internet 1954 (e.g., public Internet 1654 of FIG. 16).

The Internet gateway 1934 contained in the control plane VCN 1916 and contained in the data plane VCN 1918 can be communicatively coupled to a metadata management service 1952 (e.g., the metadata management system 1652 of FIG. 16) that can be communicatively coupled to public Internet 1954. Public Internet 1954 can be communicatively coupled to the NAT gateway 1938 contained in the control plane VCN 1916 and contained in the data plane VCN 1918. The service gateway 1936 contained in the control plane VCN 1916 and contained in the data plane VCN 1918 can be communicatively coupled to cloud services 1956.

In some examples, the pattern illustrated by the architecture of block diagram 1900 of FIG. 19 may be considered an exception to the pattern illustrated by the architecture of block diagram 1800 of FIG. 18 and may be desirable for a customer of the IaaS provider if the IaaS provider cannot directly communicate with the customer (e.g., a disconnected region). The respective containers 1967(1)-(N) that are contained in the VMs 1966(1)-(N) for each customer can be accessed in real-time by the customer. The containers 1967(1)-(N) may be configured to make calls to respective secondary VNICs 1972(1)-(N) contained in app subnet(s) 1926 of the data plane app tier 1946 that can be contained in the container egress VCN 1968. The secondary VNICs 1972(1)-(N) can transmit the calls to the NAT gateway 1938 that may transmit the calls to public Internet 1954. In this example, the containers 1967(1)-(N) that can be accessed in real-time by the customer can be isolated from the control plane VCN 1916 and can be isolated from other entities contained in the data plane VCN 1918. The containers 1967(1)-(N) may also be isolated from resources from other customers.

In other examples, the customer can use the containers 1967(1)-(N) to call cloud services 1956. In this example, the customer may run code in the containers 1967(1)-(N) that requests a service from cloud services 1956. The containers 1967(1)-(N) can transmit this request to the secondary VNICs 1972(1)-(N) that can transmit the request to the NAT gateway that can transmit the request to public Internet 1954. Public Internet 1954 can transmit the request to LB subnet(s) 1922 contained in the control plane VCN 1916 via the Internet gateway 1934. In response to determining the request is valid, the LB subnet(s) can transmit the request to app subnet(s) 1926 that can transmit the request to cloud services 1956 via the service gateway 1936.

It should be appreciated that IaaS architectures 1600, 1700, 1800, 1900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

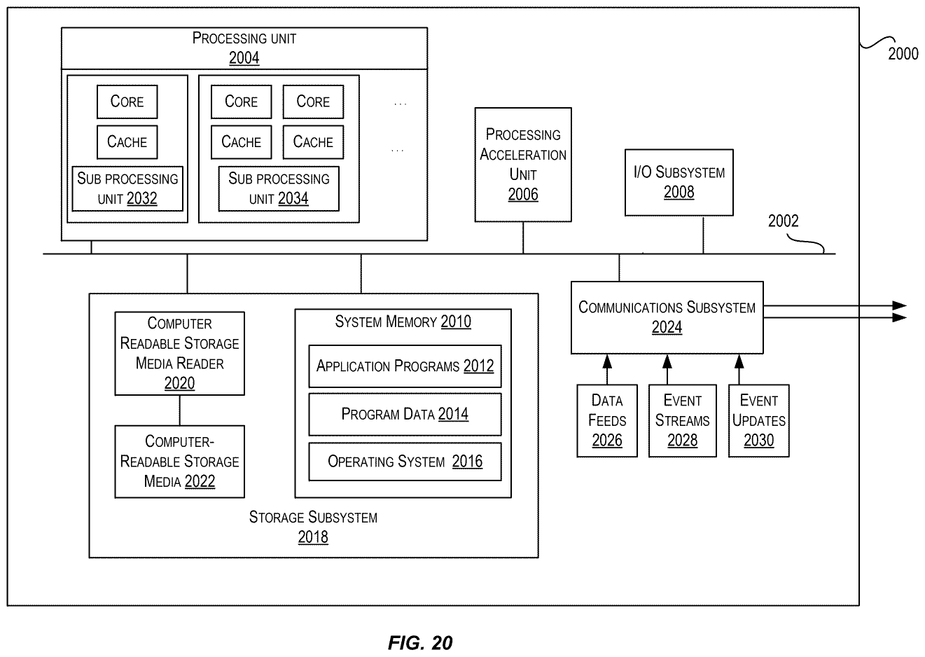

FIG. 20 illustrates an example computer system 2000, in which various embodiments may be implemented. The system 2000 may be used to implement any of the computer systems described above. As shown in the figure, computer system 2000 includes a processing unit 2004 that communicates with a number of peripheral subsystems via a bus subsystem 2002. These peripheral subsystems may include a processing acceleration unit 2006, an I/O subsystem 2008, a storage subsystem 2018 and a communications subsystem 2024. Storage subsystem 2018 includes tangible computer-readable storage media 2022 and a system memory 2010.

Bus subsystem 2002 provides a mechanism for letting the various components and subsystems of computer system 2000 communicate with each other as intended. Although bus subsystem 2002 is shown schematically as a single bus, alternative embodiments of the bus subsystem may utilize multiple buses. Bus subsystem 2002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 2004, which can be implemented as one or more integrated circuits (e.g., a conventional microprocessor or microcontroller), controls the operation of computer system 2000. One or more processors may be included in processing unit 2004. These processors may include single core or multicore processors. In certain embodiments, processing unit 2004 may be implemented as one or more independent processing units 2032 and/or 2034 with single or multicore processors included in each processing unit. In other embodiments, processing unit 2004 may also be implemented as a quad-core processing unit formed by integrating two dual-core processors into a single chip.

In various embodiments, processing unit 2004 can execute a variety of programs in response to program code and can maintain multiple concurrently executing programs or processes. At any given time, some or all of the program code to be executed can be resident in processor(s) 2004 and/or in storage subsystem 2018. Through suitable programming, processor(s) 2004 can provide various functionalities described above. Computer system 2000 may additionally include a processing acceleration unit 2006, which can include a digital signal processor (DSP), a special-purpose processor, and/or the like.

I/O subsystem 2008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 2000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 2000 may comprise a storage subsystem 2018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 2004 provide the functionality described above. Storage subsystem 2018 may also provide a repository for storing data used in accordance with the present disclosure.

As depicted in the example in FIG. 20, storage subsystem 2018 can include various components including a system memory 2010, computer-readable storage media 2022, and a computer readable storage media reader 2020. System memory 2010 may store program instructions that are loadable and executable by processing unit 2004. System memory 2010 may also store data that is used during the execution of the instructions and/or data that is generated during the execution of the program instructions. Various different kinds of programs may be loaded into system memory 2010 including but not limited to client applications, Web browsers, mid-tier applications, relational database management systems (RDBMS), virtual machines, containers, etc.

System memory 2010 may also store an operating system 2016. Examples of operating system 2016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 2000 executes one or more virtual machines, the virtual machines along with their guest operating systems (GOSs) may be loaded into system memory 2010 and executed by one or more processors or cores of processing unit 2004.

System memory 2010 can come in different configurations depending upon the type of computer system 2000. For example, system memory 2010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 2010 may include a basic input/output system (BIOS) containing basic routines that help to transfer information between elements within computer system 2000, such as during start-up.

Computer-readable storage media 2022 may represent remote, local, fixed, and/or removable storage devices plus storage media for temporarily and/or more permanently containing, storing, computer-readable information for use by computer system 2000 including instructions executable by processing unit 2004 of computer system 2000.

Computer-readable storage media 2022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 2022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 2022 may include, but is not limited to, Zip® drives, flash memory cards, universal serial bus (USB) flash drives, secure digital (SD) cards, DVD disks, digital video tape, and the like. Computer-readable storage media 2022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 2000.

Machine-readable instructions executable by one or more processors or cores of processing unit 2004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 2024 provides an interface to other computer systems and networks. Communications subsystem 2024 serves as an interface for receiving data from and transmitting data to other systems from computer system 2000. For example, communications subsystem 2024 may enable computer system 2000 to connect to one or more devices via the Internet. In some embodiments communications subsystem 2024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 2024 can provide wired network connectivity (e.g., Ethernet) in addition to or instead of a wireless interface.

In some embodiments, communications subsystem 2024 may also receive input communication in the form of structured and/or unstructured data feeds 2026, event streams 2028, event updates 2030, and the like on behalf of one or more users who may use computer system 2000.

By way of example, communications subsystem 2024 may be configured to receive data feeds 2026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 2024 may also be configured to receive data in the form of continuous data streams, which may include event streams 2028 of real-time events and/or event updates 2030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2024 may also be configured to output the structured and/or unstructured data feeds 2026, event streams 2028, event updates 2030, and the like to one or more databases that may be in communication with one or more streaming data source computers coupled to computer system 2000.

Computer system 2000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 2000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
managing, by a cached log service of a cloud-computing environment, a computing cluster comprising a plurality of demultiplexer computing nodes, a demultiplexer computing node of the plurality of demultiplexer computing nodes being configured to store control plane data within one or more containers;
obtaining, by the cached log service from a distributed streaming platform, a control plane data event that is associated with a data stream provided by the distributed streaming platform, the data stream being associated with a stream identifier;
storing, by the cached log service at the demultiplexer computing node of the plurality of demultiplexer computing nodes, the control plane data event within a container that is associated with the stream identifier;
updating, by the cached log service, container metadata corresponding to the container with metadata corresponding to the control plane data event; and
providing, by the cached log service, a payload corresponding to the control plane data event to one or more data plane clients that are subscribed to the data stream.

2. The computer-implemented method of claim 1, further comprising adding a new demultiplexer computing node to the plurality of demultiplexer computing nodes based at least in part on identifying that the one or more data clients has increased in quantity.

3. The computer-implemented method of claim 1, wherein control plane data events are distributed to the distributed streaming platform according to a first distribution scheme, and wherein the distributed streaming platform distributes the control plane data events to the plurality of demultiplexer computing nodes according to a second distribution scheme that differs from the first distribution scheme.

4. The computer-implemented method of claim 1, wherein the plurality of demultiplexer computing nodes may be scaled to service 100,000 to 1,000,000 data clients within the cloud-computing environment.

5. The computer-implemented method of claim 1, wherein the cached log service is configured to allow a plurality of data plane clients to subscribe to a data channel corresponding to a particular stream or a combination of the particular stream and a sub-stream that is associated with the particular steam.

6. The computer-implemented method of claim 1, further comprising:
receiving, from a data client, a bootstrap request corresponding to the data stream; and
providing, to the data client, a snapshot that was previously generated to include a sequential list of data stream events corresponding to the data stream.

7. The computer-implemented method of claim 1, wherein the plurality of demultiplexer computing nodes are individually configured as a smart network interface card comprising a memory for which access is obtained via a non-volatile memory express protocol.

8. The computer-implemented method of claim 1, wherein the demultiplexer computing node comprises a virtual instance corresponding to a smart network interface card and configured with a first predefined amount of random access memory and a second predefined amount of non-volatile memory express storage.

9. The computer-implemented method of claim 8, wherein the plurality of demultiplexer computing nodes initially store containers of data stream events in random access memory and subsequently persist the data stream events in the non-volatile memory express storage.

10. The computer-implemented method of claim 1, wherein the data stream is associated with the data stream and a sub-stream of the data stream.

11. A cached log service of a cloud-computing environment, comprising:
one or more processors; and
one or more memories storing computer-executable instructions that, when executed by the one or more processors, cause the one or more processors to:
manage a computing cluster comprising a plurality of demultiplexer computing nodes, a demultiplexer computing node of the plurality of demultiplexer computing nodes being configured to store control plane data within one or more containers;
obtain, from a distributed streaming platform of the cloud-computing environment, a control plane data event that is associated with a data stream provided by the distributed streaming platform, the data stream being associated with a stream identifier;
store, at the demultiplexer computing node of the plurality of demultiplexer computing nodes, the control plane data event within a container that is associated with the stream identifier;
update container metadata corresponding to the container with metadata corresponding to the control plane data event; and
provide a payload corresponding to the control plane data event to one or more data plane clients that are subscribed to the data stream.

12. The cached log service of claim 11, wherein the control plane data event is further associated with a sub-stream, and wherein the one or more containers are individually configured to store control plane data events corresponding to a common stream identifier and one or more sub-stream identifiers that are associated with the common stream identifier.

13. The cached log service of claim 11, wherein executing the computer-executable instructions further causes the one or more processors to:
receive, from a data client, a registration request indicating at least the stream identifier; and
in response to the registration request, maintain a record indicating that the data client is subscribed to the data stream corresponding to the stream identifier.

14. The cached log service of claim 11, wherein executing the computer-executable instructions further causes the one or more processors to:
receive, from a respective data plane client, a request for control plane data corresponding to a sequence number;
identify, from the container metadata, a particular container that stores a corresponding control plane data event corresponding to the sequence number;
obtain, from the particular container, a respective payload of the corresponding control plane data event corresponding to the sequence number; and
provide, to the respective data plane client, the respective payload obtained from the corresponding control plane data event and corresponding to the sequence number.

15. The cached log service of claim 11, wherein the one or more containers are associated with an active state or a closed state, wherein the one or more containers are restricted to enforce that only one container corresponding to the data stream is associated with the active state at any time.

16. A non-transitory computer-readable medium comprising computer-executable instructions that, when executed by one or more processors associated with a cached log service of a cloud-computing environment, causes the one or more processors to:
manage a computing cluster comprising a plurality of demultiplexer computing nodes, a demultiplexer computing node of the plurality of demultiplexer computing nodes being configured to store control plane data within one or more containers;
obtain, from a distributed streaming platform of the cloud-computing environment, a control plane data event that is associated with a data stream provided by the distributed streaming platform, the data stream being associated with a stream identifier;
store, at the demultiplexer computing node of the plurality of demultiplexer computing nodes, the control plane data event within a container that is associated with the stream identifier;
update container metadata corresponding to the container with metadata corresponding to the control plane data event; and
provide a payload corresponding to the control plane data event to one or more data plane clients that are subscribed to the data stream.

17. The non-transitory computer-readable medium of claim 16, wherein a single copy of the control plane data event is stored within the one or more containers at any given time.

18. The non-transitory computer-readable medium of claim 16, wherein executing the computer-executable instructions further causes the one or more processors to redistribute the control plane data event to one or more data plane clients according to the data stream and a sub-stream identified from the control plane data event.

19. The non-transitory computer-readable medium of claim 16, wherein each of the plurality of demultiplexer computing nodes executes a respective data manager, the respective data manager being a key-value store manager.

20. The non-transitory computer-readable medium of claim 19, wherein the respective data manager maintains a container table comprising the container metadata.
